(19) United States
(12) Patent Application Publication
(10) Pub. No.: US 2026/0326371 A1
(43) Pub. Date: Oct. 22, 2026

(54) Filament Tip Retaining Jacket For Extrusion Device

(71) Applicant: Brad Michael Bourgoyne, Baton Rouge, LA (US)

(72) Inventor: Brad Michael Bourgoyne, Baton Rouge, LA (US)

(21) Appl. No.: 19/184,275

(22) Filed: Apr. 21, 2025

(51) Int. Cl. B29C 64/209; B29C 64/118; B33Y 30/00

(52) U.S. Cl. CPC B29C 64/209; B29C 64/118; B33Y 30/00

(57) ABSTRACT

An embodiment of a filament tip retaining jacket for use in a fused filament fabrication (FFF) type extrusion device, this embodiment comprising a sleeve (400) appended to the leading extremity of a strand of filament feedstock (102) and conveyed by the filament through a filament feed system into and out of an extrusion device extruderhead (106). This sleeve further comprises a liner (402) for retaining a liquified portion (202) of the feedstock remaining in the extruderhead after an extrusion process, conveying it with a remaining solid portion (206) of the feedstock during retraction of the filament. Other embodiments are described and shown.

The following is a tabulation of some prior art that presently appears relevant:

U.S. Patents

| Patent Number | Kind Code | Issue Date | Patentee |
|---|---|---|---|
| 5,340,433 | A | 1994 Aug. 23 | Crump |
| 6,004,124 | A | 1999 Dec. 21 | Swanson et al. |
| 8,647,098 | B2 | 2014 Feb. 11 | Swanson et al. |
| 9,050,753 | B2 | 2015 Jun. 9 | Rodgers et al. |
| 8,827,684 | B1 | 2014 Sep. 9 | Schumacher et al. |
| 7,604,470 | B2 | 2009 Oct. 20 | LaBossiere et al. |
| 9,669,586 | B2 | 2017 Jun. 6 | Page |
| 8,926,484 | B2 | 2015 Jan. 6 | Comb et al. |
| 10,464,178 | B1 | 2019 Nov. 5 | Steeb et al. |
| 2017/0190108 | A1 | 2017 Jul. 6 | Holland et al. |
| 2023/026419 | A1 | 2023 Aug. 24 | Gibson |
| 2014/0034214 | A1 | 2014 Feb. 6 | Boyer et al. |
| 12,049,038 | B2 | 2024 Jul. 30 | Schmehl et al. |
| 2024/0051229 | A1 | 2024 Feb. 15 | Moosberg |
| 2023/0303360 | A1 | 2023 Sep. 28 | Debora et al. |
| 2023/0405933 | A1 | 2023 Dec. 21 | Tian |
| 2007/0102539 | A1 | 2007 May 10 | Riney |
| 11,065,817 | B2 | 2021 Jul. 20 | Engel et al. |

### Foreign Patents

Foreign Doc. Nr. Cntry Code Kind Code Pub. Date Patentee 110435131 CN B 2019-11-12 Yuan et al.

### Non-Patent Literature Documents

MENSLEY, MATTHEW, “Toolchanger; Game-changer? Hands-on with the Prusa XL”, AII3DP, (April 2024)
MENSLEY, MATTHEW, “Printing More with Less; Hands-on with the Prusa MMU3”, AII3DP, (October 2024)
REITINGER, VINCENT, “Bambu Lab AMS: How Does It Work Exactly?”, AII3DP, (April 2024)
“Creality K2 Plus Combo Set to Transform Multicolor 3D Printing; Introducing the CFS for Enhanced Multicolor Printing”, 3DPrinting.com, (November 2024)
HAGUE, ROB, “Multicolour Waste”, rob.rho.org.uk, (November 2024), accessed Apr. 18, 2025, URL: https://rob.rho.org.uk/2024/11/colourful.html

### CROSS REFERENCE TO RELATED APPLICATIONS

This application claims the benefit of provisional patent application Serial Number U.S. 63/636,818, filed 2024 April 21, by the present inventor, which is incorporated by reference.

### TECHNICAL FIELD

The present disclosure relates to extrusion devices that utilize a feedstock in solid contiguous-component forms such as filament, and particularly such extrusion devices as those used in additive manufacturing and fused filament fabrication (FFF) processes including 3-D printers and handheld extruders.

### BACKGROUND

In the type of additive manufacturing known as fused filament fabrication, or FFF, a three-dimensional object is fabricated by melting a solid, contiguous-component feedstock such as a strand of filament and extruding the liquified material in a controlled fashion. Filament-supplied extruders typically used in such processes are compact, efficient devices, able to produce complex part geometries from standardized and commonly available feedstock materials. Three-dimensional (3-D) printers utilizing filament-supplied extruders include relatively low-cost machines that can automate part production.

FFF 3-D printers capable of utilizing multiple materials in the same print job can further extend manufacturing capability and reduce manufacturing steps, time and cost (e.g. eliminate manual painting and assembly). Furthermore, complex multi-color and multi-material configurations that would be impractical with post-processes can be easily accomplished while the part is being printed. However, current practices of changing feedstock material within a filament-supplied extruder introduces significant inefficiencies in material use and time, as will be described.

### Note about Terminology

This disclosure will use terminology that applies to the general field of extrusion using filament feedstock, including that of 3-D printing. Terms for similar parts and components in analogous extrusion-based processes may overlap inconsistently, so terminology that is most generally applicable has been adopted here. Something to be aware of in regards to the terminology of 3-D printing is that the names of some components of the 3-D printer are often used colloquially for entire assemblies, and terms that specify different but related parts are occasionally used interchangeably. This is especially notable with the terms extruder, printhead, and hotend. The terms used in this disclosure will be applied in a clear and consistent manner according to the characterizations provided upon their use herein.

Directional terms such as downstream and upstream, as well as up and down, are used here in context relative to the orientations of embodiments as illustrated in this disclosure, and such use should not be construed to limit the scope of this disclosure to the orientations illustrated. Downstream refers to the direction in which filament moves while being extruded, and upstream refers to the direction opposite thereof. Furthermore, descriptions of tubes and tubular shapes are not being limited to circular cross sections, and include square, rectangular, polygonal, ovoid, and others.

### Filament-Supplied Extruders

A distinguishing aspect of an FFF extrusion device is an extruder which uses feedstock comprising a solid and contiguous body such as a filament and which is typically fed by a mechanism with rollers. Because a filament is composed of one continuous strand, it can be pulled, or if sufficiently confined to control buckling, pushed at any point along its length and those forces will be transmitted along its length, in particular to its leading end. This aspect of continuity makes the structure of the filament itself integral to the mechanism by which the feedstock is conveyed through the extrusion device.

A predominate type of filament-supplied extrusion device is a 3-D printer which fabricates a three-dimensional object by melting and extruding a filament feedstock with a computer controlled printhead, which is herein also referred to as an extruderhead. The extruderhead deposits the extruded material in road-like toolpaths laid down in successive layers to gradually build up a complete object. FFF processes are also commonly referred to as fused deposition modeling (FDM), and one of the earliest patents for 3-D printers of this type is U.S. Pat. No. 5,340,433-A by inventor S. Scott Crump issued in 1992.

FIG. 1 illustrates a typical FFF 3-D printer of a type commonly available today, showing major components pertinent to this disclosure. With such printers, a filament feedstock 102, is usually provided coiled around a spool for storage and dispensation. Filament 102 is inserted into a filament feeding mechanism 104, which in turn feeds it into an extruderhead 106. Extruderhead 106 includes a means of liquification 108 and a point of extrusion 110, which is the specific location that the extruded material exits the extruderhead 106. Extruderhead 106 is carried by a carriage 112 which positions extruderhead 106 and point of extrusion 110 relative to a build plate 114 upon which a fabricated object 116 is built according to computer control. As filament feedstock 102 is fed into extruderhead 106 by feeding mechanism 104, it is liquified by means of liquification 108 and subsequently extruded through a nozzle orifice at point of extrusion 110 to build fabricated object 116. The exact configuration of an FFF 3-D printer may vary from that shown in FIG. 1 while still utilizing the same principles, for example using other means not shown to control the positioning of the extruderhead relative to the build plate.

Hand-held extrusion devices, some of which are commonly referred to as 3-D pens or 3-D printing pens but also include plastic extrusion welders, use a similar extrusion process for manual additive fabrication and repair without CNC motion control. Similar to the extruderhead and filament feeding mechanism of a 3-D printer combined into a hand-held device and using the same kind of filament feedstock, these extruders are manually positioned and controlled by the operator to make and repair objects. Extrusion welders are another kind of manually controlled extrusion device which utilize filament or rod-shaped feedstock and are used to fabricate and assemble plastic objects.

Looking again at FIG. 1, the two main components of a filament-supplied extruder can be identified: feeding mechanism 104 and extruderhead 106. Typically, feeding mechanism 104 is made up of a motor driving a geared roller and an idler roller, or set of geared rollers, which pinch the strand of filament 102 to feed it into or retract it out of extruderhead 106. After the leading end of the filament passes through feeding mechanism 104, it remains connected to feeding mechanism 104 by the portion of the filament following behind (referred to here as the following portion) which extends through feeding mechanism 104. Thus, feeding mechanism 104 is able to propel the leading end of the filament forward and back by driving the following portion of the filament. FIG. 1 shows feeding mechanism 104 as mounted on the printer frame separate from extruderhead 106, but common alternative configurations not shown locate the feeding mechanism on carriage 112 immediately upstream of the extruderhead.

Extruderhead 106 of the filament extruder includes a means of liquification 108 which typically comprises a tube heated by electric resistive heating elements. This heated tube forms a melt-chamber with a nozzle that has a sized orifice at its outlet. This orifice defines point of extrusion 110. As feeding mechanism 104 pushes filament 102 into extruderhead 106, means of liquification 108 liquifies the leading portion of filament 102. This heated section of the extruderhead is called the hotend. The solid filament following behind this liquified leading portion functions as a piston to push the liquified material out of the hotend nozzle at point of extrusion 110. Generally, a guide tube at the inlet of extruderhead 106 receives filament 102 and guides it into the hotend. To maintain the filament's functionality as a piston inside this section, this guide tube is usually cooled with a heatsink and fan. This actively cooled section is often called the coldend of the extruderhead.

The basic design of this kind of filament-supplied extruder was established by the early patents for FFF 3-D printers, typified by S. Scott Crump's U.S. Pat. No. 5,340,433-A cited above, which are now expired. Despite a proliferation of refinements to 3-D printers developed since then, this design has largely retained the same basic pattern comprising a tubular body with a constricting orifice that installs from the outlet side of the extruderhead and counter to the direction of feed. Furthermore, these components are generally discussed as components separate and distinct from the filament, as devices that act upon a filament fed into them.

### Challenges of Filament-Supplied Extruders

Despite the advantages offered by filament-supplied extruders, they also present complicating difficulties when put to the demands of high speed 3-D printing. Some of these challenges can be largely categorized as follows: maintaining effective temperature control, maintaining separation between areas of hot and cold, mitigating negative effects of the viscous nature of the liquified feedstock, preventing uncontrolled oozing of liquified feedstock when not extruding, and the difficulty of fully removing liquified feedstock from the extruderhead when changing feedstock.

Heating the filament quickly enough to extrude at a high rate and then also cooling it when not extruding is a challenge. The materials used in FFF 3-D printing are typically characterized as having low thermal conductivity. This means that the speed of printing is often limited by the ability to transfer heat into the filament. Operating at higher temperatures and creating a higher temperature differential between the hotend and the filament can accommodate higher extrusion rates. However, extrusion temperatures that are too high can quickly overheat and degrade the filament material. As long as enough fresh filament is moving into the hotend to absorb the heat, it will not overheat. If the extrusion suddenly pauses, then the filament inside the hotend will continue to heat up quickly. Even if the hotend also stops actively heating at the same moment, the thermal capacitance of the hotend can continue to heat and thermally degrade the stationary filament. Maintaining the proper temperature balance with fluctuating extrusion speeds is problematic. Ideally, the extruderhead would be able to both quickly heat and quickly cool the liquified filament to accommodate variable extrusion.

Maintaining the necessary temperature gradient between the hotend and coldend, and between the liquified portion of the filament and the solid portion presents another difficulty. If the heat of the hotend conducts upstream into the coldend and the solid portion of the filament, then the solid portion can soften too much to effectively function as a piston. The softened filament can bulge out and impinge on the interior walls of the guide tube, causing insufficient extrusion. Severe instances can cause the filament to stick inside the coldend and jam the extruder.

Another problem that can disrupt the temperature separation is backflow of the liquified filament, which can travel upstream around the solid portion of the filament. This liquified material can then cool and solidify, adhering the filament to the inside of the coldend and jamming the extruder.

The behavior of viscous liquified filament material at the tip of the hotend can also present complications. As the extruderhead completes one extrusion path and moves to start the next, the viscous extrusion can stick to the tip of the extruderhead. A trailing string of extrusion material can be pulled out between the fabricated object and the extruderhead. The deposited extrusion may also be dragged off the fabricated object, resulting in an imperfection in the printed object. These imperfections can cause a cascade into further problems with the print.

Uncontrolled oozing of liquified filament out of the nozzle during pauses in extrusion can leave defects on the fabricated object. This oozing can be caused by pressure that builds up within the hotend, which will cause the extrusion to continue briefly after the feeding mechanism stops. Furthermore, if the extruderhead remains heated for an extended period while not extruding, the liquified material inside the hotend can be overheated and ooze or drip out of the nozzle.

The stringing and oozing behavior of the liquified filament material can be mitigated by reversing the filament feeding mechanism to retract the filament back a short distance. This retraction reduces pressure and can create a slight suction in the hotend, pulling back the filament. However, this retraction also retracts the heated portion of the filament into the coldend, bringing heat into the coldend and exacerbating heat creep. Retracting can also drag backflow into the coldend. This is particularly problematic if the filament is extruded and retracted repeatedly in rapid succession over an extended period of time, which is a common occurrence in high-speed complex prints.

Various approaches have been used to mitigate some of these problems. In regards to heat creep and backflow, a common approach with lower temperature filament materials is to line the extruderhead inlet with a material with a low surface friction and thermal conductivity such as polytetrafluoroethylene (PTFE). To further control annular backflow, the inlet tube has sometimes been made slightly smaller in diameter than the liquifying tube to seal more closely around the solid portion of the filament. For higher temperatures that would degrade such guide tube materials, a polished, smooth metal bore with a connecting barrel having a small cross-sectional area creating a heat break between the hotend and coldend has been used. Combining a metallic cold end with a very smooth bore with a highly conductive heatsink is another common approach. All of these approaches are variations of the basic configuration of extruderheads established by the original patents discussed above.

Another major challenge typical of any extruder arises when changing filament materials, either for a different material type or different color. Any such filament change inevitably requires a complete removal of the previously used filament from the extruderhead which cannot be achieved through standard retraction. When filament is retracted, some portion of liquified material is left in the extruderhead. FIGS. 2 and 3 illustrate the prior art processes of extrusion and retraction. FIG. 2 shows the prior art state of filament feedstock 102 inside extruderhead 106 during extrusion and while idle in readiness for extrusion. Filament leading portion 202 is inserted inside hotend 204 of extruderhead 106 and liquified by means of liquification 108. Filament following portion 206 follows leading portion 202 into coldend 210, often bulging slightly at filament transition zone 212. During extrusion, following portion 206 functions like a piston at transition zone 212, pushing leading portion 202 out of nozzle 214 and through point of extrusion 110.

FIG. 3 shows the prior art process of full retraction. During retraction, filament following portion 206 is withdrawn by filament feeding mechanism 104 (FIG. 1) from extruderhead 106, pulling much of transition zone 212 with it. If pulling is continued, transition zone 212 is stretched from its attachment to leading portion 202 into a thin trailing string 302 which finally breaks apart, leaving the majority of leading portion 202 inside extruderhead 106. Transition zone 212 remains deformed as it solidifies, becoming an irregularly shaped new leading portion 304 that can potentially jam inside filament feeding mechanism 104 and feeding paths. Trailing string 302 can also foul filament feeding mechanism 104. Some recent 3-D printer designs include a cutting blade that severs following portion 206 before retracting it out of extruderhead 106, creating a clean new leading portion and leaving transition zone 212 inside extruderhead 106. Whatever amount of filament feedstock 102 that is left inside extruderhead 106 after full retraction must be pushed out and purged by the new filament before clean extrusion of new material can occur. Depending on the nature of the filament materials in use, such purges can consume a significant amount of material and time.

### Currently Available Solutions for Multi-Material 3-D Printing:

Multi-material capable 3-D printers have been sought for as long as FFF 3-D printers have been available. In fact, Crump's early U.S. Pat. No. 5,340,433-A, disclosed methods of multi-material printing. In order to achieve multi-material capabilities in a filament-supplied extrusion device, changing the filament used also requires either changing the extruderhead used, or cleaning it through purging.

Until recently, the most common approach to achieving multi-material capability has been to simply add additional extruderheads carried alongside the primary extruderhead on the printer carriage, each with its own filament feeding mechanism and filament feedstock. The biggest drawback of this approach is the significant added cost and complexity of the additional components, as well as the loss of build area occupied by the additional extruderheads. As the extruders are a major component in a 3-D printer, multiple extruders can easily double the overall cost of the printer. Other complications include the added weight that must be carried by the printer carriage, the risk of an idle extruderhead dripping liquid filament on the part, and the additional risk of the idle extruderhead colliding with the part being fabricated as it is printed. Even combining multiple extruderheads each with a dedicated filament feed mechanism into one compact extruder assembly will only partially mitigate the loss of usable space and does little to offset the costs.

Variations to this multiple extruderhead approach combine dual or multi-function components that switch between selectable filaments, extruderhead assemblies, or nozzles. The limitation of this approach is that significant additional mechanical and controller complexity is introduced with the benefits limited to a small number of alternative materials.

A yet more mechanically complex solution is to utilize a tool changer, an automation common in CNC systems. Filament feed mechanisms and extruderheads are combined into multiple self-contained extruder modules that are stored at a tool station or rack separate from the build area with an additional mechanism to change out extruder modules automatically during the printing process. This solution maintains the full build area, avoids the penalties of weight, and mitigates risks of collision and oozing created by idle extruders on the printer carriage. However, it does so at the expense of much more complex mechanical and control systems.

Variations to the tool changer approach which offset some of these disadvantages interchange different individual components or assemblies rather than the entire extruder module. Some interchangeable components include filament holders, hotend assemblies, nozzles, or some combination thereof. In each of these variations, the expense and weight of redundant components are reduced to varying degree. However, they all still require additional positioning operations, as well as coupling and decoupling mechanisms. Many also require specialized components, such as storage racks, tool cribs, receptacles, compartments, locking mechanisms, changing arms, actuators, or print tool grippers. All of these designs require major modification of existing printer configurations and are not easily implemented into existing printer designs.

A different approach involves splicing together separate segments of different filaments pre-measured to match the amounts needed in the extrusion sequence, and then feeding the spliced filament into the 3-D printer's feeding mechanism. The advantage of this solution is that it only requires a single filament feed mechanism and extruderhead, and it can be compatible with virtually any FFF 3-D printer. However, the disadvantage is that it requires a very complex and costly mechanism to manage, measure, cut, and splice multiple filaments into one sequence that choreographs perfectly with the required extrusion sequence. Also, extra material needs to be added to each splice to allow for purging between filament types. If no purge between filament types is used, each material mixes and each color bleeds into subsequent materials and colors.

More recently, multi-material storage and handling systems have been developed that automatically change filaments in printers that use a single primary filament feeding mechanism and extruderhead. This kind of system is configured to automatically select and feed the required filament from a storage of multiple spools to the primary feeding mechanism of the printer. These systems are modular add-ons and are usually external to the printer. Each system can handle a predetermined number of spools, and multiple units can often be linked together to expand capacity. The system is equipped with at least one secondary feeding mechanism and feed tube that can feed and retract filament to the primary filament feed mechanism in the printer. A feed tube manifold or hub connects the external feed tubes to the primary printer filament feeding mechanism. Since the secondary feeding mechanism is only moving the filament to and from the primary feeding mechanism and disengages when the primary feeding mechanism takes over, these systems can be relatively simple and inexpensive. The modularity of the components also reduces their expense.

A major challenge of these multi-material systems utilizing a single extruderhead is a wastage of material and time created by the purging process. In order to change filaments with these systems, the extruderhead typically first stops printing and moves to a purge station or tower, sometimes having to move through a filament cutting station first. Next the previous filament is retracted out of the extruderhead and feeding mechanism, and is replaced by the new filament. This new filament is extruded in a purging operation, sometimes also called flushing, to clean out residue of the previous material, usually ejecting the purged material as waste or extruding it into a disposable object called a prime tower. If a color change is going from dark to light, or if the filaments are materially incompatible, the amount of purging needed can be extensive. Finally, the extruderhead moves to wipe the nozzle clean and returns to continue the print. This all occurs every time a filament change occurs, which can add up to hundreds or even thousands of changes in one print. Thus, even though the capability to print multi-material is extremely useful, the wastage with these systems can be substantial.

As a study of the effects on filament usage and print time of multi-color printing with this kind of automatic multi-material handling system, a standard “Benchy” model was used as a simulated test case. This model measured 50.8 mm by 50.8 mm by 48 mm, occupied a volume of 15,546 mm³, and was specified with two colors, red and black. The model was sliced in preparation for 3-D printing using the Bambu Lab Bambu Studio software (version 1.10.1.50) on a Bambu Lab A-1 Mini 3-D printer equipped with a 0.4 mm nozzle and an AMS Lite multi-material system. The simulated print estimates provided by the manufacturer's software were used to predict the performance of the printer. Default settings were used unless otherwise noted. On this printer each change in filament entails moving the extruderhead to a filament cutter, moving the extruderhead to a flushing station, exchanging filaments, flushing (i.e., purging) residual filament from the extruderhead, moving the extruderhead to a wiping station, and priming the extruderhead with new filament. Three print cases were simulated and the predicted totals of print time and filament usage were compared. For the first case, a single color for the entire model was specified and the software predicted a print time of 55 minutes and material usage of 11.27 grams. This case gives the time and material needed to print the model itself with no losses to filament changes. For the second case, two colors were specified but the filament flushing was set to zero and priming was turned off. The software predicted 170 filament changes with extruderhead movements to cut the filament at each change and with a print time of 268 minutes and material usage of 11.27 grams. For the third case, two colors were specified and default settings were used for flushing and priming. The software predicted a print time of 414 minutes and material usage of 11.27 grams for the model, 76.81 grams for flushing, and 15.57 grams for priming, for a total of 103.65 grams. These values demonstrate the inefficiencies introduced by cutting, flushing, and priming the filament at each color change. Cutting and filament exchanges increased the print time from 55 to 268 minutes, an increase of 387%. Cutting, filament exchanges, flushing, and priming increased the print time from 55 to 414 minutes, an increase of 653%. Flushing and priming increased the material usage from 11.27 to 103.65 grams, an increase of 820%. While these estimates are specific to one test model, printer, and set of print parameters, they illustrate the significant inefficiencies that can be introduced by current multi-material handling systems in even a simple two-color model.

### SUMMARY

In accordance with one embodiment described herein a method and device for a fused-filament fabrication (FFF) type device comprises a tubular jacket appended to and encasing the leading extremity of a solid contiguous-body feedstock such as a strand of filament feedstock which inserts into and retracts from a heated portion of an extruderhead of the device. The jacket is conveyed with the filament as it feeds through a filament feed system of the device and into an inlet end of the extruderhead. When inside the extruderhead, the jacket functions as a liner and a conduit by which liquified filament can be conducted through the extruderhead and extruded without substantial physical contact between the liquified material and the internal surfaces of the extruderhead. When the filament is retracted out of the extruderhead, the jacket remains appended to the filament and is conveyed along with the filament out of the extruderhead and through the feed system, retaining potentially liquified feedstock within it. Additional embodiments disclose an air assist system used in conjunction with the jacket to assist in removing residual liquified filament that was not retained in the jacket from the extruderhead outlet and jacket exterior.

The present invention also includes a filament feedstock for use in a fused filament fabrication (FFF) type extrusion device in combination with a filament tip retaining jacket on (or attachable to) its leading extremity, the jacket including a sleeve which comprises a liner for retaining a liquified portion of the feedstock remaining in the extruder head after an extrusion process, conveying it with a remaining solid portion of the feedstock during retraction of the filament.

The present invention also includes a filament tip retaining jacket on (or attachable to) a leading extremity of a filament feedstock for use in a fused filament fabrication (FFF) type extrusion device in combination with the filament, the jacket including a sleeve which comprises a liner for retaining a liquified portion of the feedstock remaining in the extruder head after an extrusion process, conveying it with a remaining solid portion of the feedstock during retraction of the filament, the sleeve being sized and shaped to attach to the feedstock leading extremity and retain the liquified portion of the feedstock during use.

### Advantages

Accordingly several advantages of one or more aspects providing a filament tip retaining jacket are as follows: expediting the clearing of the extruderhead when reloading with an alternative filament; eliminating the need for cutting the filament when changing materials; mitigating the need for lengthy purging of the nozzle which is otherwise required when changing filament materials using current methods; and when used in conjunction with multi-material handling systems, enabling single extruderhead 3-D printers to print multi-material and multi-color objects in significantly less time than when such systems are used without an embodiment of the filament jacket.

Advantages of these aspects further include providing a filament tip retaining jacket that facilitates the rapid removal of the unextruded liquified filament feedstock out of the heated section of the extruderhead and away from its outlet when not being extruded, thereby modulating the amount of heat introduced to the filament when it is not being extruded and reducing a risk of overheating the filament or the cool section of the extruderhead. This rapid retraction accordingly facilitates higher print temperatures and higher print speeds and reduces uncontrolled leakage of the liquified material from the outlet. In some embodiments this retraction will also reduce the risk of collisions between the lower-most extremity of the extruderhead assembly and the printed object.

Additional advantages of embodiments that provide a stream of air blown into the bore of the extruderhead around the jacket and its outlet include improved detachment of the extruded filament from the outlet when the extruderhead is moved away from a printed feature, thereby reducing lifting and stringing.

Another advantage of some embodiments providing that each jacket is specific to each filament is that extrusion characteristics such as extrusion bead-size which are determined by each jacket become integral to each spool of filament. Accordingly, the extrusion characteristics of each filament/jacket assembly can be tailored to its specific use in a print. When each jacket is specific to each filament, jackets are automatically changed when the filament is changed, mitigating nozzle clogging and wear. Furthermore, when multiple filaments each with its own jacket are used, different nozzle characteristics can be used for different portions of the same print.

Other advantages of one or more aspects will be apparent from a consideration of the drawings and ensuing description.

### BRIEF DESCRIPTION OF THE SEVERAL VIEWS OF THE DRAWINGS

FIG. 1 is a perspective overview of a typical FFF 3-D printer.

FIG. 2 is a side sectional view of a typical FFF 3-D printer extruderhead showing a typical prior art extrusion process.

FIG. 3 is a side sectional view of a typical FFF 3-D printer extruderhead showing a typical prior art full retraction process.

FIG. 4 is a side cut-away view of one embodiment of the disclosed filament tip retaining jacket showing its overall configuration and its interior.

FIG. 5 is a side sectional view of an extruderhead showing a filament with one embodiment of the disclosed filament tip retaining jacket before extrusion.

FIG. 6 is a side sectional view of an extruderhead showing the extrusion process with one embodiment of the disclosed filament tip retaining jacket.

FIG. 7 is a side sectional view of an extruderhead showing the retraction process with one embodiment of the disclosed filament tip retaining jacket.

FIGS. 8, 9, 10, 11, 12, and 13 are side sectional views of extruderhead internal components with different embodiments of the jacket showing various means of forming a barrier to flow between the outlet end of the jacket and the inside of the extruderhead.

FIGS. 14, 15, and 16 are cutaway views of the inlet end of different embodiments of the jacket showing various embodiments of a slip-drag coupling of the jacket.

FIG. 17 is a perspective view of an embodiment of the jacket inlet end with a duck-bill opening and slit to accommodate irregularities in the filament diameter.

FIGS. 18 and 19 are side sectional views of an extruderhead showing an embodiment of an air assist system connected to the filament feed side of the extruderhead.

FIGS. 20, 21, 22, and 23 are side sectional views of the nozzle area of an extruderhead outlet showing an embodiment of an air assist system connected to the extrusion outlet side of the extruderhead.

### REFERENCE NUMERALS USED IN DRAWINGS

102. Filament feedstock
104. Filament feed mechanism
106. Extruderhead
108. Extruderhead means of liquification, liquifier
110. Extruderhead point of extrusion
112. Printer carriage
114. Printer build plate
116. Fabricated object
202. Filament leading portion
204. Hotend
206. Filament following portion
208. Extruderhead inlet
210. Coldend
212. Filament transition zone
214. Extruderhead nozzle
302. Filament trailing string
304. Filament new leading portion
400. Filament tip retaining jacket
402. Jacket elongated body
404. Jacket interior passage
406. Jacket inlet end
408. Jacket outlet end
410. Jacket slip-drag coupling
412. Jacket slip-drag bite
502. Extruderhead bore
504. Extruderhead barrel
602. Extruderhead means of stoppage
802. Jacket outlet extension
902. Nozzle annular gap
1002. Jacket outlet tapered seal
1102. Jacket outlet outer seal
1202. Extruderhead bore inner seal
1302. Interlocking interface seal
1402. Protuberance, slip-drag bite
1502. Longitudinal ridge, slip-drag bite
1602. Barb, slip-drag bite
1702. Slit in jacket inlet end
1802. Air assist air flow
1804. Annular gap
1806. Air assist assembly
1808. Air assist assembly head
1810. Air assist filament boot seal
1812. Air assist inlet
1814. Air assist conduit
1816. Air source
1818. Nozzle annular seal
1820. Air assist air exhaust
1822. Extrudate
1824. Solidified extrudate
1826. Stringing extrudate
1828. Air assist nozzle exhaust
1830. Air vent location
2002. Air assist nozzle assembly
2004. Nozzle air inlet
2006. Nozzle air channel
2008. Nozzle air outlet
2010. Extruderhead bore extension
2012. Nozzle air exhaust vent
2014. Nozzle exhaust air

### DETAILED DESCRIPTION

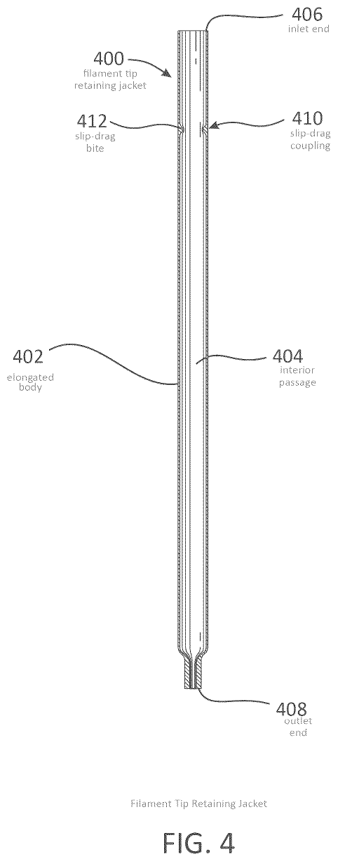

### FIGS. 4, 5, 6 and 7—First Embodiment

This disclosure provides embodiments of a device that bridges operations of the filament and extruderhead in one new component, herein referred to as a filament tip retaining jacket. This jacket attaches to the leading end of the filament and is loaded and conveyed by the filament into the extrusion device, acting as part of the filament. Passing through the feeding mechanism and pathways, the jacket inserts into the feed side of the extruderhead along with the filament.

Once inside the extruderhead, the jacket functions as a liner, containing and conveying the filament as it is liquified and extruded. Thus, while inside the extruderhead, the jacket is integral to the function of the extruderhead. Once extrusion is stopped or paused, the jacket once again functions as part of the filament. It is retracted with the filament, and retains the liquified portion of the filament with the solid portion.

One embodiment of the filament tip retaining jacket is illustrated in FIG. 4. Filament tip retaining jacket 400 comprises a thin-wall tube or sleeve with an elongated body 402 further comprising an interior passage 404 connecting an inlet end 406 and an outlet end 408. Elongated body 402 further comprises a means of slidable attachment referred to as a slip-drag coupling 410 with its means of holding referred to as a slip-drag bite 412, located in this embodiment within interior passage 404.

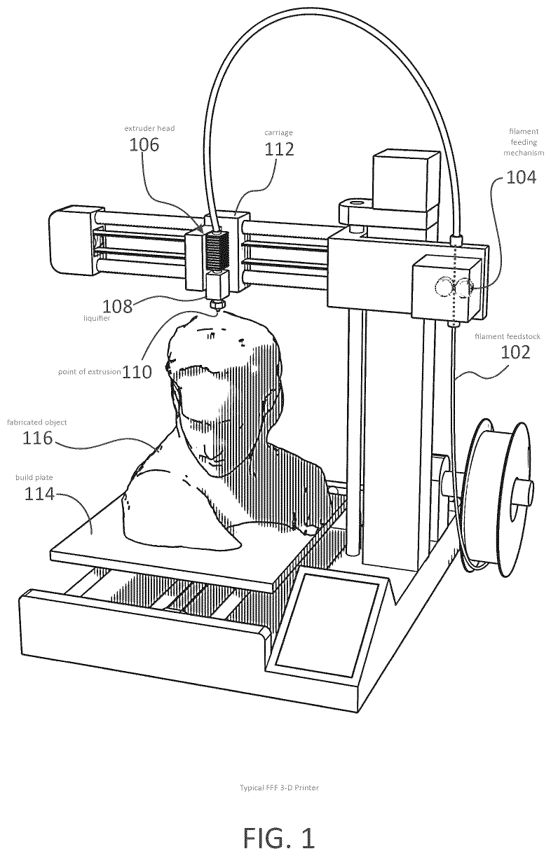

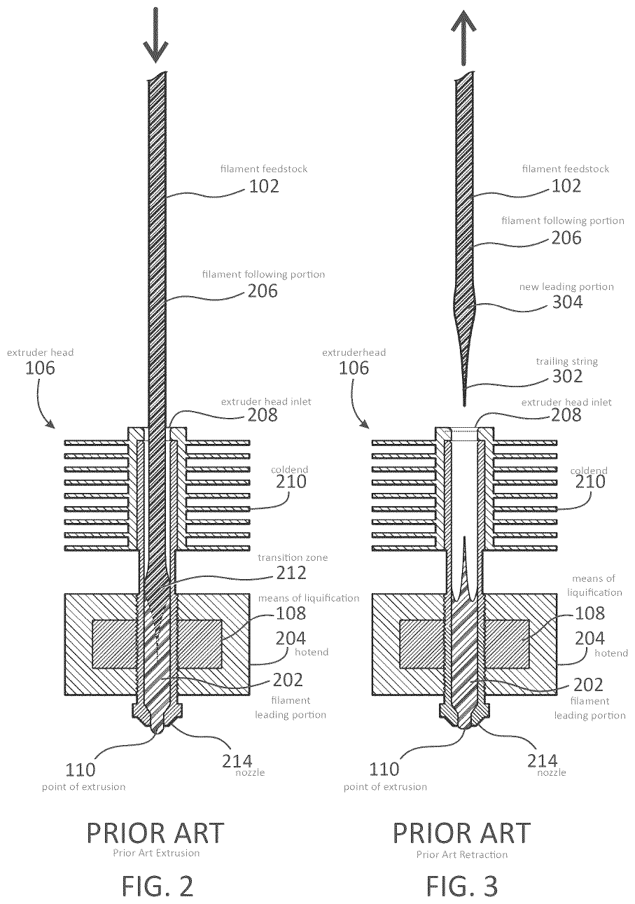

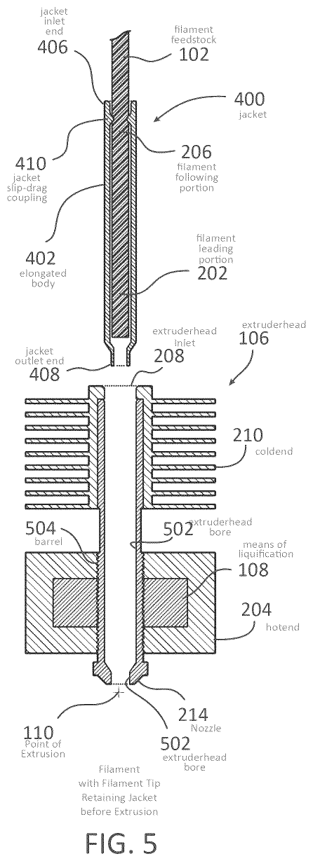

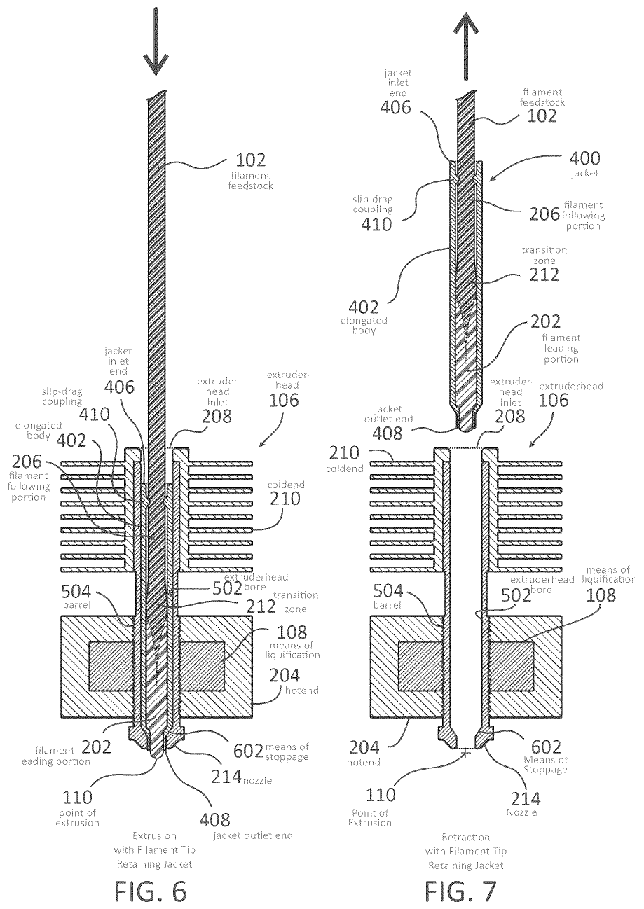

FIG. 5 shows this embodiment with filament 102 inserted inside jacket body 402, before insertion into extruderhead 106. Extruderhead 106 comprises an interior surface and passage, or bore 502 which is defined by a tube-shaped barrel 504. FIG. 6 shows the embodiment during extrusion with filament 102 and jacket body 402 inserted into bore 502 of extruderhead 106. Jacket body 402 is of a size and shape that is able to pass forward and backward through filament feed mechanism 104 (FIG. 1) and other filament passageways of the extrusion device or 3-D printer without obstruction. Body 402 is also sized to fit into extruderhead bore 502 in such a way that heat from means of liquification 108 is readily transferred to and through body 402 into interior passage 404. The outer surface of body 402 is overall streamlined, but a texture can be included that comprises very shallow knurls, ridges, or grooves to promote the grasping of the body by filament feed mechanism 104. Similarly, the outer surface of jacket body 402 could be coated by or made of a material that promotes this grasping action.

Interior passage 404 is sized larger than the diameter of filament feedstock 102 so that it can freely accept its insertion. In this embodiment, slip-drag coupling 410 comprises at least one protuberance on the interior surface of passage 404, conditionally reducing the effective inner diameter of inlet 406 to slightly less than the outer diameter of filament 102 in that location. Furthermore, outlet end 408 in this embodiment steps down or tapers to a smaller size. Its outer diameter reduces to fit within nozzle 214 of extruderhead 106, and its inner diameter produces the desired diameter of an extrusion bead extruded at point of extrusion 110.

In this embodiment, the step down in the inner diameter of extruderhead bore 502 to the smaller diameter of nozzle 214 before point of extrusion 110 acts as a means of stoppage 602, preventing jacket body 402 from exiting through extruderhead 106. Also, in this embodiment jacket outlet end 408 is sized to fit within nozzle 214 and extend beyond it to point of extrusion 110, so that jacket body 402 functions as a continuous liner throughout extruderhead bore 502 from within coldend 210 through hotend 204 out of nozzle 214 to point of extrusion 110.

FIG. 5 also illustrates the manner in which filament 102 inserts into jacket body 402, with two protuberances of the slip-drag coupling 410 impinging on filament 102. This impingement acts on filament 102 in such a way to substantially impede relative motion between jacket body 402 and filament 102 as they move together forward or backwards in extruderhead bore 502, through filament feed mechanism 104 (FIG. 1), or through any of the filament passageways in the printer. At the same time this impingement does not prevent filament 102 from sliding forward relative to the jacket and within jacket interior passage 404 during extrusion (FIG. 6) when jacket body 402 is stopped by means of stoppage 602.

The length of jacket 400 is related to the length of the heating zone of extruderhead liquefier 108. In this embodiment jacket 400 is long enough to extend throughout this heated zone and coldend 210 such that inlet end 406 and slip-drag coupling 410 remain cool enough to retain filament 102. Conversely, jacket 400 is also short enough to traverse bends in the filament feed system. The optimal length will depend on the configuration of the device or printer.

The thickness of the walls of the jacket body 402 is determined by its function. As the jacket body 402 must be small enough to fit through feeding mechanism 104 and feed pathways, its outer diameter is defined by the smallest inner diameter of feeding mechanism 104 and these pathways. As the jacket body 402 must fit over the filament that carries it, its inner diameter must be larger than the outer diameter of the filament for which it is designed. Tolerances of interacting components must also be accommodated. Finally, the structure of the jacket functions as a liquid flow barrier at extrusion pressures, and maintains its hold on the filament, under the stresses encountered in the feed pathways and feeding mechanism rollers. Its structural performance is further related to the materials from which the jacket is made.

A working prototype of the filament retaining jacket demonstrating this embodiment was fabricated to operate with a filament with a diameter of 1.5 millimeters and with an existing FFF 3-D printer that was designed to use standard 1.75-millimeter diameter filament. This printer was fitted originally with a nozzle with a 0.6-millimeter orifice that was subsequently drilled out to provide a 1.0-millimeter orifice. The jacket body was sized to fit inside the existing filament feed system and extruderhead bore of the printer which at its smallest internal diameter measured 2.0 millimeters. Fabricated from stock 15UTW gauge stainless-steel hypodermic tubing with an outer diameter of 1.83 millimeters and an inner diameter of 1.63 millimeters, this jacket was able to accept filament with a diameter of 1.5 millimeters. To make the jacket outlet, a short piece of 20×HW gauge stainless-steel hypodermic tubing with an outer diameter of 0.91 millimeters and an inner diameter of 0.41 millimeters was silver soldered into the end of the jacket body to produce the diameter stepdown at the outlet. This jacket outlet fit within the modified 1.0-millimeter nozzle. Slip-drag coupling features, or bites, were made by punching two shallow divots into the external surface of the inlet end to make corresponding protuberances on the interior surface. These divots were then filled externally with silver solder. Additionally, a series of very shallow circumferential grooves were rolled into the external surface of the tube body.

Although this filament tip retaining jacket prototype was able to fit within the internal diameter of the original feed system of the FFF 3-D printer used, minor modifications of the printer's feed system was required for reliable operation. Because these feed systems are designed to feed perfectly smooth and flexible filament, there were some places in the system that could snag or obstruct the jacket as it was retracted. The modifications performed included replacing the flexible feed tubes with tubes having the same outer diameters and larger internal diameters, as well as smoothing internal transitions between feed tubes and connections, and within the feed tube hub. The filament runout sensor contact arm required beveling on its reverse edge to avoid snagging the jacket upon retraction, and the extruder drive gear required modification to reliably accommodate a slightly larger range of diameters, allowing it to grip both the 1.5-millimeter filament and the 1.83-millimeter jacket.

While this prototype was fabricated to use with 1.5-millimeter filament to successfully test the functionality of this design in a standard 3-D printer with minor modifications, the design can be easily made to work with more common 1.75-millimeter filament. One approach would be to scale it up for use with 1.75-millimeter filament in a 3-D printer designed for use with 2.85-millimeter filament, another standard filament diameter. Alternatively, a 3-D printer designed for use with 1.75-millimeter filament could be modified by enlarging the inner diameter of its filament feed systems and extruderhead by approximately 0.25 millimeters to accommodate a jacket scaled for 1.75-millimeter filament. One unanticipated advantage revealed by the initial prototype is that with a simple changeout of the hotend and nozzle, the printer used with the 1.5-millimeter caliber jacket could still be used with unjacketed 1.75-millimeter filament as originally designed.

### Operation—FIGS. 5, 6, and 7

Although the process of 3-D printing using the filament tip retaining jacket is very similar to printing in a conventional 3-D printer without it, the function of the jacket allows significant differences. A principal difference between a filament tip retaining jacket and the conventional extruderhead components that it works with or replaces is how it loads into the extruderhead. In conventional extruderheads, components such as the barrel and nozzle normally install into the extruderhead from the outlet side, whether they are installed manually by the operator or automatically by a tool changer. In contrast, the filament tip retaining jacket inserts with the filament through the filament feeding mechanism and into the extruderhead from the feed-side of the head. This feed-side loading, or breech-loading, characteristic enables the jacket to function in an entirely new way, as not just an integral component of the extruderhead assembly, but also as an integral component of the filament system.

FIG. 5 illustrates the state of the process before extrusion is begun. Before loading the filament into a printer, the jacket 400 is attached to the end of the filament 102 by inserting filament leading portion 202 into jacket inlet end 406 until it engages with slip-drag coupling 410. Filament 102 is then loaded into the printer generally as normal except that it is stopped before filament leading portion 202 and jacket outlet end 408 extend beyond coldend 210 into hotend 204.

FIG. 6 illustrates an extrusion process with one embodiment of the filament tip retaining jacket. Before beginning the extrusion operation, hotend 204 is brought up to extrusion temperature by means of liquification 108. To begin extrusion, filament 102 and jacket body 402 are fed forward into hotend 204. Jacket outlet 408 will reach extruderhead stoppage 602 and will be stopped from moving further through extruderhead bore 502, with jacket outlet 408 extending through nozzle 214 to point of extrusion 110. Heat transfers from hotend 204 through jacket body 402 and subsequently to leading portion of filament 202, liquifying it.

Continued feeding of filament following portion 206, which has remained solid, will cause it to slide through slip-drag coupling 410 and function as a piston, displacing liquified leading portion 202, and forcing it out of point of extrusion 110 as extrudate. In this process following portion 206 then becomes filament leading portion 202. This new leading portion 202 is liquified in turn and extruded in a continuous process of extrusion. This entire process of liquification and extrusion occurs within jacket body 402, which acts as a continuous liner from coldend 210, through hotend 204, to point of extrusion 110. Throughout the extrusion process, filament jacket body 402 is pressed into hotend 204 against stoppage 602 by the force of filament 102 feeding forward, with no further restraining mechanism or lock needed to lock it in place.

To stop the extrusion process, filament feeding mechanism 104 (FIG. 1) is reversed, and filament 102 is retracted. FIG. 7 illustrates retraction with this embodiment of jacket 400. Because jacket body 402 is free to move backwards relative to extruderhead bore 502, and slip-drag coupling 410 substantially restrains relative motion between jacket body 402 and following portion 206, jacket body 402 will travel backwards with filament 102. Because the unextruded liquid filament leading portion 202 is retained within jacket body 402, it will also travel with following portion 206.

How far filament 102 and jacket 400 are retracted will depend on how long the extrusion process is paused before beginning again. For very brief pauses, filament 102 will be retracted only a short distance, often less than 1.0 mm. In this case jacket body 402 will remain in hotend 204 and continue to be heated, maintaining extrusion temperature. For longer pauses, or to end the extrusion process completely, filament 102 will be retracted the length of hotend 204 so that jacket outlet end 408 is at least within coldend 210. In this case jacket body 402 will begin to cool rapidly, and liquid filament 202 within it will solidify. To resume extrusion, filament 102 is again fed forward and the process repeated.

If this stage of the extrusion process with this filament is completed and a filament of a different color or material is to be used, the filament and its jacket are retracted all the way out of the feed mechanism and replaced with the new filament and its own jacket. As the liquified filament was contained within the jacket body throughout the extrusion process, the extruderhead bore will be left substantially clean and ready for the new filament to commence printing without purging.

### Jacket Re-Loading Procedure

A jacket can be changed with a new one, or reused on a new spool of filament. When a jacket and filament have been used for extrusion, the filament necessarily goes through a process of liquification and solidification. When solidifying inside the jacket, the filament becomes molded to the jacket interior passage, effectively adhering them together. Separating them requires heating the tip of the jacket to the softening temperature of the filament and pulling them apart. The jacket can then be placed on a new filament, preferably of the same kind and color. If the filament is in fact different, the jacket will need to be purged before first re-use.

Generally, the jacket slip-drag coupling is sufficient for holding the jacket onto the filament during the loading process. The filament may also be heated, formed into, and solidified within the jacket to increase the holding force and remove voids, priming the jacket/filament assembly for printing.

Should the 3-D printer run out of filament during a print, the refill spool could be loaded without a jacket. As the jacket from the previous filament will still be positioned inside the hotend, most printers will be able to feed a new filament into the jacket just as if it were reloading into a conventional hotend and nozzle configuration.

Using Jackets with Multi-Material Systems

The utility of the filament tip retaining jacket is particularly manifest when used in conjunction with an automated multi-material handling system. When each spool of filament stored in the multi-material system is equipped with a filament tip retaining jacket, changing filament materials during prints becomes fast and efficient. When proper control settings are used, the changing process can be as short as the time required for the filaments to move to and from their storage positions, with purging unnecessary. The extruderhead would not even need to move away from its paused print position. It would simply pause, switch filaments, and continue. As there is no cross-contamination of materials inside the extruderhead, no wasteful purging to clean the extruderhead is needed.

As a comparison between the time required to print a two-color model using a multi-material system with and without filament tip retaining jackets, the simulated prints of a “Benchy” model described above can be considered. The simulated print using the system's default settings for filament cutting, purging, and priming required an estimated 170 filament changes, 103.65 grams of material, and 414 minutes of print time. Of that material, 92.38 grams were estimated to be consumed by purging and priming for an average material loss of 0.54 grams per filament change. Of that time, 359 minutes were estimated to be consumed by filament changing procedures including cutting, purging, and priming, or 2 minutes and 6 seconds per filament change. The same model printed in one color and no filament changes required 55 minutes. Thus, even if a multi-material system using filament tip retaining jackets required 30 seconds for every filament change to move the filament to and from the extruderhead, it could potentially print this two-color model in an estimated 140 minutes, or about a third of the time required by the same system without the jackets. Preliminary testing of the filament tip retaining jacket prototype indicated that on some 3-D printers the filament exchanges could require far less time than 30 seconds. According to these simulations, such a system with jackets could potentially also use just an estimated 11% of the filament consumed by the same system without the jacket.

The versatility of some embodiments of the jacket can be further leveraged by using them with a multi-material handling system. For those embodiments in which the extrusion-bead size is defined by the jacket outlet, jackets with differently sized outlets can be used on different filaments. Thus, different areas of the print can be printed with different extrusion-bead sizes and layer thicknesses. For example, a precision extrusion-bead measuring 0.4 mm wide can be used for printing surface details, while a 0.8 mm wide extrusion-bead can be used for infill and support structures. The larger extrusion-bead size will substantially increase print speeds, reduce print time, and increase structural strength of the printed part, while the smaller extrusion-bead will maintain fidelity to fine details. This kind of versatility is currently available only on printers with multiple extruders or tool changing systems.

### Using Jacket Retraction to Control Heat Flow

The retraction process using some embodiments of a filament tip retaining jacket introduces new methods of flow and heat control in the extruderhead that are independent of the response time of the heating elements of the hotend. Because the jacket and the liquified filament within it retract with the rest of the filament, it is possible to control with precision how and when heat is introduced into the filament independent of heater control and hotend thermal capacitance. By modulating how far back into the extruderhead that the jacket is retracted, the amount of heat transferred from the hotend to the filament can be modulated. Even if a high temperature is maintained in the hotend, the less that the jacket extends into the hotend, the less heat that will be transferred to the filament. To maintain an intermediate level of heating, the jacket can be moved into and out of the hotend repeatedly at predetermined intervals. Thus, the jacket and leading portion of the filament it contains can be kept warm in anticipation of imminent extrusion without the risk of overheating, while also not having to wait on a cooled off hotend to heat up to restart extruding. The jacket and filament are simply fed forward into the hotend, and extrusion is resumed.

By limiting the introduction of heat to only the time that the filament is actively extruding, a precise balance between heat flow and material flow can be established and maintained, even at elevated print rates. This added control can allow the use of higher hotend temperatures with higher material flow rates with less risk of overheating. The continual introduction of filament during extrusion acts as a heat sink, maintaining a lower temperature in the coldend. As long as this flow is continued and balanced with the heat input, the filament will not overheat. When extrusion pauses and the flow stops, the jacket and the filament within it can be rapidly pulled away from the heat source before it has a chance to overheat. Once in the coldend, the jacket and the liquified filament within it can be quickly cooled. Because the jacket itself has little thermal capacitance, it will transfer proportionately little additional heat from the means of liquification into the coldend. Thus, the ideal of rapid heating and cooling of the filament tip can be achieved without significant modification of either the hotend means of liquification or the coldend heatsink and cooling system. Furthermore, since the jacket and liquified filament can be physically separated from the hotend, new cooling means can be employed to cool them sequestered from the hotend. This isolated control will improve cooling without affecting the performance of the hotend. Thus, not only will the filament tip retaining jacket operate with minimally modified conventional extruderheads, it will enable innovation in extrusion practices.

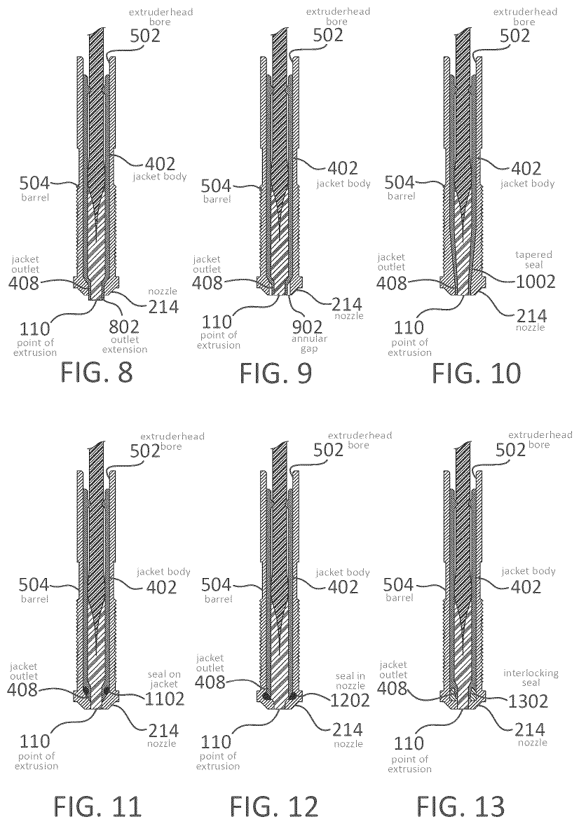

### Additional Embodiments—FIGS. 8 to 13

FIGS. 8 to 13 illustrate additional embodiments with various aspects of the jacket outlet end. How jacket outlet end 408 interfaces with extruderhead nozzle 214 and point of extrusion 110 influences how the jacket will function as a liner. The jacket creates a flow barrier between the liquified filament and the interior surfaces of the extruderhead. This barrier function includes when extrusion conditions create backpressure, inhibiting the liquified filament from flowing back into extruderhead bore 502 around the outside of jacket body 402. Back pressure is often inadvertently created when the first layer of the print is being extruded onto the build plate. If the amount of extrudate is not precisely calibrated to the distance between the point of extrusion and the build plate, excess extrudate can be squeezed back into the extruderhead. Various means of sealing the outlet end with the nozzle to prevent backflow are provided in these embodiments.

FIG. 8 illustrates a simple means of maintaining continuity of the jacket as liner. In this aspect, jacket outlet 408 has an outlet extension 802 that extends through and beyond extruderhead nozzle 214 to point of extrusion 110. Thus, the liner created by the jacket is physically uninterrupted through the length of extruderhead bore 502 to point of extrusion 110. This extension 802 beyond the tip of extruderhead nozzle 214 also creates a relief zone along its sides for any backpressure. If backflow does occur, it will follow the path of least resistance which is up and out, around outlet extension 802 and if extreme enough, on to the exterior of extruderhead nozzle 214.

The embodiment shown in FIG. 9 is a variation on this aspect. Here, jacket outlet 408 extends into nozzle 214 and ends flush with its tip. A nozzle annular gap 902 between the outer surface of outlet 408 and the inner surface of nozzle 214 is provided to establish backpressure relief. With this configuration, jacket outlet 408 is sheltered within the body of the nozzle 214, and any backflow would have to be severe enough to fill the gap 902 before pushing material up into the nozzle 214. Additionally, slits or openings through the side of the nozzle could be added that provide for exit of reverse-flowing extrudate prior to continuing up around jacket body 402.

FIG. 10 shows an embodiment utilizing a long-tapering conical interface 1002 to seal jacket outlet 408 within extruderhead bore 502. Just as in a needle-valve, a long taper creates a large area of surface contact that will seal effectively, especially while pressure from the feed mechanism is applied during extrusion. The taper ratio can be optimized to promote sealing contact. A sufficient taper ratio would mitigate the self-locking action that can occur with very long tapers. The optimal degree of taper would be influenced by the materials used for the interfacing surfaces of the taper.

Another benefit of a long taper interface is the increase in surface area of heat transfer relative to the internal volume. A long taper in the interior of this section of the jacket will also increase the rate of heat transfer between the hotend and the filament inside the jacket. Thus, the filament would be liquified faster allowing faster print speeds.

While FIGS. 9 and 10 shows jacket outlet 408 as flush with nozzle 214, in both cases the outlet could be configured to extend beyond nozzle 214 as shown in FIG. 8. Utilizing the jacket as a liner to point of extrusion 110 beyond the tip of nozzle 214 offers multiple benefits. In particular, this extended liner eliminates places within the extrusion path for residual filament to remain after retraction. Such a liner extension also helps prevent back flow. Additionally, because it becomes the furthest extension of extruderhead 106 and because it lifts away from the build area when retracted, it increases the clearance gap between the lowest physical part of the extruderhead assembly and the fabricated object during retractions. Often printers are programmed to perform short vertical movements called “z-hops” or “lifts” during retraction before travel movements to ensure that the extruderhead does not collide with parts of the fabricated object that have inadvertently shifted upwards. However, z-axis movements are usually actuated by linear screw mechanisms and are slower than the belt and pulley mechanisms often used on the x-axis and y-axis. The accumulated time required for these repeated z-hops can significantly increase print times. Rapid z-hops can also create serious vibrations that interfere with precise printing. Some designs have attempted to reduce some of these negative effects of retraction by providing an extruderhead that is spring loaded to automatically lift above the build plane when not extruding. However, the extruderheads that would typically incorporate this kind of spring mechanism are of a much larger mass than a filament tip retaining jacket of this disclosure. Rapid vertical movements of such a large mass would inevitably create proportionately large vibrations. In contrast, for embodiments that include a jacket outlet extension, the z-hop will occur automatically and smoothly with each retraction, at the speed of the retraction with virtually no additional vibration.

In situations in which a single fixed nozzle outlet is desired for the entire print, such as when specially hardened nozzles or multicolor mixing nozzles are used, jacket outlet 408 can be configured to end inside nozzle 214. The embodiment shown in FIG. 10 could be configured this way, as tapered interface 1002 provides an effective seal where ever it ends. FIGS. 11, 12 and 13 show other embodiments of jacket outlets that seal inside the nozzle. FIG. 11 shows a seal 1102 mounted in an outer gland, or groove, on the jacket outlet 408. Component 1102 and mating surfaces like 1302 could also function primarily or additionally as a wiper to promote bore sweeping or cleaning. The term “seal” and “sealing” in these claims is extended to include packing, wiper, scraper, and brush type elements and actions that may not provide complete sealing action. A seal located near the jacket outlet travels the length of extruderhead bore 502 every time the jacket is inserted and retracted and serves to sweep the bore clean. Also, because seal 1102 is carried on the jacket, it will be replaced with each new jacket and does not require a long design life.

FIG. 12 shows a similar embodiment wherein a seal 1202 is mounted in a gland inside extruderhead bore 502. In this instance, seal 1202 will not be subjected to wear to the same degree as seal 1102. The jacket manufacture is also simplified in this configuration. Both seals could be combined into one configuration, with seal 1202 in bore 502 providing the primary seal, and seal 1102 on jacket inlet 406 providing a redundant seal with additional bore-sweeping functions.

FIG. 13 shows an embodiment wherein a seal 1302 is formed by an interlocking interface between the contacting surfaces of jacket outlet 408 and extruderhead bore 502, or of a seal between them.

Both seal 1102 and seal 1202 could be standard O-rings or washer shaped gaskets made of high temperature resistant elastomer, depending on the filament materials with which the jacket is designed to be used. Silicone, polyimide, polytetrafluoroethylene (PTFE), and fluoroelastomer (FKM) can have service temperatures above 260 degrees Celsius, which would be sufficient for commonly used lower temperature filament materials, especially if a short service life were required. Perfluoroelastomer (FFKM) is an elastomer seal material which offers service temperatures above 300 degrees Celsius, which would be sufficient for many higher temperature filaments. Other materials familiar to a person skilled in the art would be suitable for these O-rings including composite formulations.

These seals 1102, 1202, and 1302 could also be similar to piston rings made of springy materials such as metal that employ spring-like action to conform against contact surfaces. Such seals would effectively seal even at temperatures above 300 degrees Celsius. They would perform well in scraping and brush type functions. Suitable metals include brass, bronze, steel, stainless steel, as well as other alloys commonly used for metal-to-metal spring activated seals.

Embodiments using other means of sealing or wiping the extruderhead bore are not illustrated here that would be evident to a person skilled in the art. For example, the jacket itself could be made of a compliant and resilient material, such as tubing made or coated in one of the above listed O-ring materials, increasing its sealing action against the bore of the extruderhead. Likewise, the bore itself could be so coated.

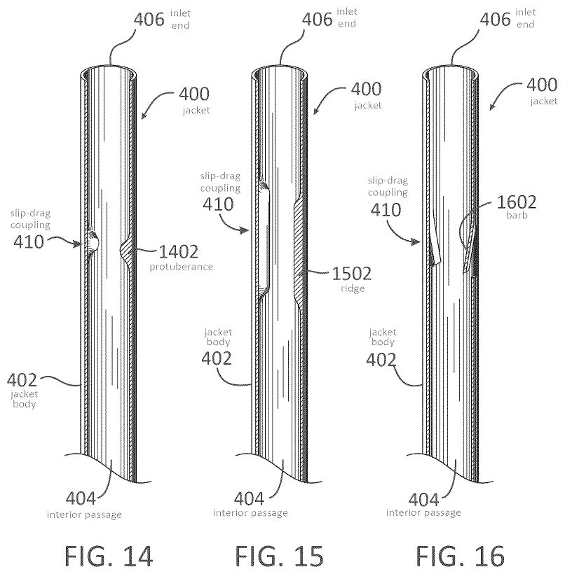

### Additional Embodiments—FIGS. 14 to 16

FIGS. 14 to 16 describe various embodiments of slip-drag coupling 410. This means of attachment is named a slip-drag coupling because it allows filament 102 to slip into jacket body interior passage 404 when filament 102 pushes forward, but drags when filament 102 is pulled backwards, dragging jacket body 402 back with it. The aspect of slip-drag coupling 410 that provides the holding force for this dragging is referred to here as a bite 412 (FIG. 4). It is so called because in many embodiments, although not in all that are possible, it produces its holding force by biting or constricting the filament.

Maintaining a secure connection between the jacket and the solid filament is another aspect of the jacket design. The jacket remains attached to the filament while being pushed forward as well as when pulled back through the filament feed system. When feeding forward, a narrowing of the jacket outlet is sufficient to prevent the solid filament from pushing through the jacket. During retraction when the jacket is being pulled back with the filament, this slip-drag coupling holds the jacket to the filament, especially when part of it is still hot from extrusion. Even though the outer body of the jacket is designed to pass freely through the extruderhead bore and filament passages, there will inevitably be points of increased resistance. The means of attachment should be sufficient to overcome any encountered resistance, especially during retraction. However, during extrusion when the jacket is hot and the filament leading portion is liquified, the slip-drag coupling allows the following portion of the filament to slide continuously into the jacket. Moreover, this slip-drag coupling should also be durable enough to pass through the rollers of the filament feed mechanism without deforming and losing functionality.

FIG. 14 shows a slip-drag bite comprising at least one node or protuberance 1402 situated on the inner surface of jacket interior passage 404 in the vicinity of inlet end 406. If a plurality of such protuberances is used, they would function most consistently if evenly spaced around the circumference of jacket body 402. FIG. 14 shows two protuberances 1402 symmetrically arranged across the axis of jacket body 402, but they could also be offset longitudinally. Protuberance 1402 should be of such height that it decreases the local overall diameter of the interior passage 404 to slightly less than that of the filament. Thus, friction is introduced between the filament and the interior surface of the jacket. The amount of friction will be influenced by the size, shape, and number of protuberances 1402. This friction should be enough to hold the jacket to the filament while being conveyed, but not so much as to stop the filament from being pushed through during extrusion. The protuberance could be rounded as shown, or sharpened to a point. The optimal size, shape, and number of the protuberances will also be influenced by the type of filament material for which the jacket is designed. For example, a more rigid material such as polylactic acid (PLA) could require fewer and smaller protuberances than a softer, more compliant material such as thermoplastic elastomer (TPE).

FIG. 15 shows a similar slip-drag coupling comprising at least one longitudinal ridge 1502. Essentially an elongated protuberance, it functions in the same manner as protuberance 1402 of the FIG. 14 embodiment. Other configurations of raised features are feasible, including but not limited to transverse ridges that run circumferentially around the jacket, or at least one ring or band that narrows the diameter of the interior passage 404. Slip-drag coupling features should be made resistant to the rolling action of the feed mechanism rollers.

FIG. 16 shows a more complex means of attachment comprising at least one spring barb bite 1602. Barbs could be fashioned by cuts into of the jacket body wall or other means where each barb comprises a sharp edge positioned inward and pointing away from jacket inlet 406. These barbs 1602 would be arranged and located in a similar manner as the protuberances 1402 in FIG. 14. In a jacket body made of work-hardened metal or spring metal, barbs made this way would spring inward with resilience. Alternatively, a small section or band of spring material with which the barbs are made could be affixed to the jacket body. The advantage of spring barb 1602 is that as the filament moved forward through jacket body 402, barb 1602 would be pushed flush with the walls of jacket body 402 and introduce less resistance. When the filament is pulled back however, barb 1602 would spring inward, and the sharp edges would grab into the filament firmly. A further advantage of this feature is that it would allow for a greater range of filament diameter irregularity.

Other slip-drag coupling embodiments that are not illustrated are also feasible. Simply imparting an ovoid cross-section to the jacket inlet so that the flattened sides press against the filament would be sufficient, provided that the jacket material was resilient enough to maintain that shape through the filament feed mechanism. Thickening at least one area of the wall of the jacket body would likewise function to impart a drag between the filament and the jacket. Also, a jacket internal surface having an elevated coefficient of friction, such as a knurled area, a pattern of shallow ridges and furrows, or a patch of non-slip coating would produce the necessary friction. Aspects from two or more illustrated embodiments could be combined, for example a protuberance could have a sharpened forward angle like a barb. The important aspect is introducing enough friction to hold the jacket onto the filament, without preventing the filament from sliding forward during extrusion. Devices could include sliding or rolling parts such as collets and slips. The action of seating or unseating the jacket into the nozzle bore could actuate the mechanism. Various methods of joining tubes to rods with direction-dependent or location dependent action that would be evident to a person having ordinary skill in the art fall within the scope of this disclosure.

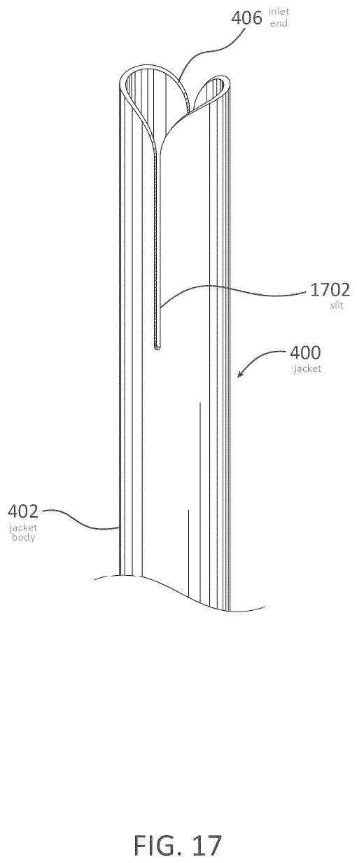

### Additional Embodiments—FIG. 17

FIG. 17 illustrates an aspect by which the jacket inlet allows the insertion of filament with variations or irregularities in diameter. Filaments of a nominal size are manufactured within an allowable tolerance for cross sectional shape and diameter. Accordingly, the actual inner diameter of the jacket inlet is slightly larger than the specified filament. A filament tip retaining jacket both allows the insertion of the filament as well as maintains secure attachment during retractions. This attachment can be facilitated by additional compliance from the jacket to fit around the filament.

FIG. 17 shows one embodiment of this fit compliance. In this embodiment, inlet end 406 of the jacket is scalloped into a duck-bill configuration, with at least one slit 1702 cut a short distance longitudinally in jacket body 402. The duck-bill opening guides the filament end into inlet 406, reducing snagging on blunt edges. Slit 1702 allows inlet 406 to spread open slightly and accommodate slightly larger diameter filament. The more slits that are cut and the longer that they cut into the jacket, the more accommodating the inlet will be.

Other means of fit compliance not illustrated can include longitudinal pleats or crimps at the inlet end, which would flex to fit larger diameters. Moreover, split 1702 could be supplemented with an elastic or springy split-ring or band wrapped around the inlet end to elastically hold the inlet at a smaller diameter and provide or supplement the slip-drag coupling holding force.

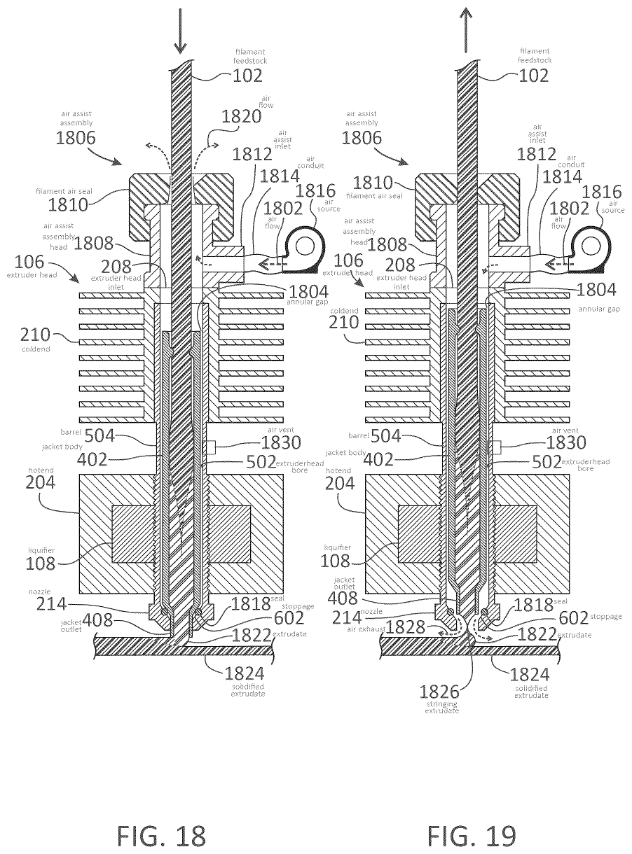

### Additional Embodiments—FIGS. 18, 19, 20, 21, 22, and 23

The annulus formed between the jacket outer surface and extruderhead bore and the valve type action of the jacket movements inside the bore provide for previously unavailable means of extrudate control, residue clearing, and active filament cooling. For example, the annulus can serve to direct a flow of air to break the trailing string of extrudate that forms at the end of extrusions, and to clear the point of extrusion of residual filament material after extrusions. The movement of the jacket inside the extruderhead bore can emulate the function of a valve, blocking and unblocking air passages into and out of the annulus.

The use of air to assist in a tooling process is a common practice, such as with air assist systems in CNC laser cutting, the use of compressed air in plasma torch metal cutting, or even more commonly, using air to blow away cutting chips in milling, drilling, and cutting operations. In many other extrusion processes, such as those used to dispense fiberized filaments and hot melt adhesives, air blown around the dispensing nozzle is a principal component of the forming mechanism. In laser cutting, a stream of air is injected through the laser focusing nozzle to push exhaust smoke and particles away from the lens and to assist the cutting action of the laser. A stream of air can perform a similar function in the extruderhead of an extrusion device using a filament tip retaining jacket.

An external jet of air from a nozzle positioned close to the outlet of the extruderhead could create this air assist, but such a configuration would be limited by several factors. Firstly, a jet of air exiting a nozzle into an unconfined space loses much of its force very close to the nozzle's exit as it spreads out and mixes with the surrounding air. This would necessitate a close proximity between the air nozzle and the extruderhead outlet, an area which is also limited to being above the build plane defined by the point of extrusion. If the air nozzle is not in immediate proximity of the extruderhead outlet, an air flow with significantly higher pressure and flow rate would be required. If the stream of air is introduced from a single location to the side of the extrusion outlet and angled down at it, it would be difficult to control the movement of the fluid extrudate and avoid splattering it across an area of the fabricated object. This aspect would require either multiple air nozzles around the extruderhead outlet, or a baffle or sleeve surrounding it to direct and concentrate the stream of air. Furthermore, it's effects would be limited to the outside of the extruderhead bore. Introducing the stream of air inside the extruderhead bore would be more effective than one blowing on it externally from above.

In conventional extruderheads, introducing air into the bore of the extruderhead is complicated by the pressure and temperature inside the nozzle created by the extrusion process. Any air inlets opening into the extruderhead bore would necessarily require some means of preventing backflow of liquified extrusion material into the air passages during extrusion. Prevention of backflow could be achieved with high enough air pressure or by check valves. However, higher pressure systems are much more expensive, check valves that can withstand the temperatures involved are mechanically complicated, and the space around the nozzle outlet is limited. In addition to a needed complexity of higher air pressure or valves, any air assist system that timed the air flow with extrusions and retractions would require additional control systems to regulate it. Accordingly, the benefit offered by an air assist system with a conventional extruderhead is tempered by the added cost, complexity, and maintenance required.

A filament tip retaining jacket enables the use of an air assist system without the additional aforementioned complexities being required. The annular space between the exterior of the jacket and the interior bore of the extruderhead offers an efficient location to introduce air during retraction. This annular gap is isolated from the liquified extrusion materials during extrusion, and offers communication through the entire length of the extruderhead. Moreover, whereas this gap can be closed off during extrusion, it would open automatically with each retraction of the jacket. Therefore, the air flow could be automatically controlled by the movement of the jacket in the extruderhead without additional external control. Instead of being specifically controlled, the air source could be continuously activated. Thus, the only additions required by this kind of air assist system with a filament tip retaining jacket is an air source and air pathway.

FIG. 18 illustrates an embodiment that comprises a stream of air 1802 blown into the annular space between jacket body 402 and extruderhead bore 502 by way of extruderhead inlet 208. FIG. 19 illustrates the retraction of filament 102 and jacket body 402, and the release of air 1802 through an annular gap 1804 between the outside surface of jacket body 402 and extruderhead bore 502. After air flow 1802 travels through nozzle 214, it flows out extruderhead bore 502 around jacket outlet 408. This embodiment includes an air assist assembly 1806 comprising an air assist assembly head 1808 extending the filament feed passageway defined by extruderhead bore 502 upstream towards filament feeding mechanism 104 (FIG. 1). Air assist assembly head 1808 has an interior surface substantially flush with extruderhead bore 502. Air assist assembly head 1808 is also sealed with an elastomeric boot 1810 which also seals around filament 102. This air assist boot 1810 is compliant enough to create a substantially airtight seal, while also allowing jacket body 402 and filament 102 to pass through without obstruction. An air assist air inlet 1812 connects the interior of air assist assembly head 1808 with an air conduit 1814. Air conduit 1814 comprises a tube or pipe connecting the upstream end of air inlet 1812 to an air source 1816 which can be an air pump, compressor, storage tank, blower, or fan. If small enough, air source 1816 can be integral to air assist assembly 1806 or mounted near it on printer carriage 112 (FIG. 1). A larger air source 1816 can be mounted on the printer frame, or be provided as a component separate from the printer. When air source 1816 is not carried by printer carriage 112, air conduit 1814 would comprise a jointed or flexible tube of sufficient length and arrangement to allow free movement of extruderhead 106. Air assist assembly 1806 can be made as a separate assembly and securely attached as an extension of extruderhead inlet 208 as shown, or it can be completely integrated as part of coldend 210 construction or as part of a Bowden filament feed tube (not shown).

As shown in FIG. 18, when jacket body 402 is fully seated in hotend 204 and stopped by stoppage 602 during extrusion, annular gap 1804 is created between jacket body 402 and bore 502 of extruderhead 106. In this embodiment, gap 1804 is sealed by nozzle seal 1818. Seal 1818 can comprise means of sealing including those enumerated above in the discussion of FIGS. 10 to 13. With the outlet end of extruderhead 106 sealed by jacket outlet 408 contacting nozzle seal 1818, and with air assembly boot 1810 sealing the filament inlet of extruderhead 106, air flow 1802 produced by air source 1816 will generate positive air pressure within extruderhead 106. This excess air pressure could be designed to vent through a pressure operated exit point, or the source of air pressure can be designed to operate continuously in a dead-headed condition. For example, air assembly boot 1810 could be designed to operate in a manner similar to a pressure operated valve, deforming at a predetermined air pressure and allowing air exhaust 1820 to vent out of air assist assembly 1806. Alternatively, a pressure operated air exhaust vent could be located at another location. The forward motion and seating of the jacket into the hotend could also trigger the opening of the air exhaust vent. During extrusion, liquified filament is extruded from jacket outlet 408 in the form of extrudate 1822, which subsequently solidifies into solidified extrudate 1824.

FIG. 19 shows the process of retraction with this embodiment. The filament feeding mechanism reverses direction, pulling filament 102 and jacket body 402 away from nozzle 214. Extrusion stops, and as jacket outlet 408 lifts from the point of extrusion, the end of extrudate 1822 can be pulled along and form a trailing string 1826, potentially lifting the end of extrudate 1822 off of solidified extrudate 1824. At the same time as jacket outlet 408 moves back, nozzle seal 1818 opens, allowing nozzle air 1828 to flow through annular gap 1804, around jacket outlet 408, and out nozzle 214. Nozzle air flow 1828 will break extrudate string 1826 before it solidifies and blow it out of nozzle 214. Any residual extrudate remaining in nozzle 214 will likewise be pushed out by nozzle air flow 1828. A close tolerance between the outside of the jacket outlet 408 and the inside walls of nozzle 214 will intensify the velocity of the nozzle air flow 1828.

Depending on the nature of air source 1816, other positive effects can result from nozzle air flow 1828. If air source 1816 is capable of creating only a short, intense burst of air such as that produced by the blowdown of a chamber of compressed air or single action syringe-style pump, the result will be a simple detachment of extrudate string 1826 and clearing of nozzle 214. If air source 1816 produces a continuous flow with high volume and high flow rate such as that produced by a fan or blower, nozzle air flow 1828 will push the still fluid extrudate 1822 with a smoothing action. If air source 1816 produces a continuous flow with high volume, high flow rate, and high pressure such as that produced by a continuous air pump or compressor, nozzle air flow 1828 will be strong enough to also blow extrudate off the tip of jacket outlet 408, and influence the shape of the surface of the fabricated object. When air flow 1802 is properly calibrated, this spreading of the end of extrusion 1822 on the surface of the object can improve its adhesion to the object as well as improve the surface appearance of the finished object.

The embodiment described here is an air assist system made possible by the use of a filament tip retaining jacket and a few modifications of an existing extruderhead design. In addition to the jacket, it would typically require an air source, a length of tubing, and an adapter boot on the extruderhead inlet. The air assist inlet could be drilled into the side of most extruderhead cold ends or Bowden tubes, and a short length of thick-walled silicone foam tubing attached with zip-ties could form the boot seal. The air source could be a simple air pump or blower, providing only a modest amount of air pressure of one to two psi, about the equivalent that an average person can puff with their mouth. A small aquarium air bubbler pump would be sufficient. Because the air flow is concentrated inside the nozzle, a relatively low air pressure will be effective. Furthermore, no external control of the air source would be required.

Further variations and improvements of the kind of air assist system disclosed here are within the scope of this disclosure. For example, air assist air inlet 1812 could be located in alternate positions on the extruderhead bore 502. If air assist air inlet 1812 were located on the extruderhead 106 anywhere upstream of the means of liquification, it's function would largely remain the same as that of the position shown on air assist assembly 1806. An inlet at position 1830 at the heatbreak downstream of coldend 210 would allow air flow 1802 to contribute a cooling effect to the coldend 210 during extrusion. Likewise, if air inlet 1812 is upstream of coldend 210, a pressure operated air vent at location 1830 at the heatbreak would allow air flow 1802 to add to the cooling of the coldend during extrusion.

An air source connected to extruderhead 106 at the location of 1830 would produce flow upward during extrusion and downward upon retraction, wherein the location of the jacket within the bore would function as a shuttle valve and control the dispensation of the air. When retracted, the jacket would cover the exit points of the passages that conduct air upwards and open the exit of the passages that conduct air out of the nozzle.

Movement of air flow 1802 through annular gap 1804 could be facilitated by the addition of at least one longitudinal channel, groove, or flute in at least extruderhead bore 502 or jacket body 402. Air flow through a provided channel or flute would vary in heat exchange performance from flow in an annular gap and this could be exploited to limit cooling on the hot end.

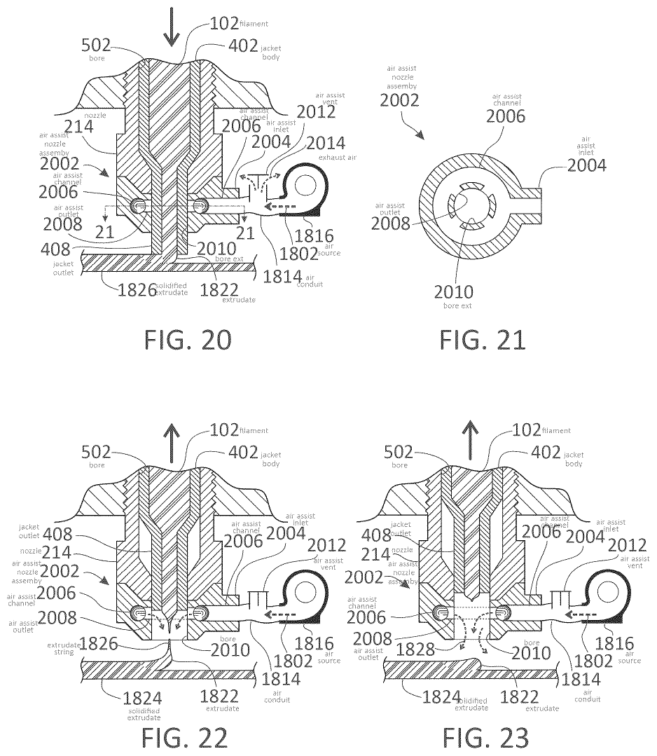

FIGS. 20 to 23 illustrate an alternate position for an air assist air inlet at nozzle 214 that would have significant differences from the embodiments shown in FIGS. 18 and 19, being located downstream of the means of liquification 108. FIG. 20 shows this embodiment during extrusion, with an air assist nozzle assembly 2002 mounted onto the extruderhead outlet at nozzle 214. In this configuration nozzle air inlet 2004 would connect to air channel 2006 which would in turn connect to at least one air outlet 2008 in a bore extension 2010 of extruderhead bore 502. Bore extension 2010 would surround jacket outlet 408 during extrusion. Note, the longitudinal length of jacket outlet 408 is shown here proportionately longer than physically necessary to provide visual clarity of the illustration. Bore extension 2010 would be substantially continuous with bore 502.

Alternatively, air assist nozzle assembly 2002 could be made an integral part of nozzle 214, with its air pathways integrated into the body of nozzle 214. Air channel 2006 could be a direct path between nozzle air inlet 2004 and a single air outlet 2008. Alternatively, as shown in the cross-sectional view of FIG. 21, it can follow a circumferential route around bore extension 2010 and connect a plurality of air outlets 2008 to establish an evenly distributed air flow into bore extension 2010. Likewise, even spacing between a plurality of air outlets 2008 would promote even distribution. Note, FIG. 21 omits jacket outlet 408 and air conduit 1814 for clarity, and illustrates air outlets 2008 at positions rotated 45 degrees away from the axis that they are depicted in FIGS. 20, 22, and 23. This rotated position avoids a direct path between air nozzle inlet 2004 and any one air outlet 2008, as a direct path to one outlet and not others would create the possibility of uneven air flow.

Similar to the embodiment illustrated in FIGS. 18 and 19, nozzle air inlet 2004 would connect upstream to air conduit 1814 and air source 1816, these having configurations similar to that of the previous embodiment. Having an air inlet position in proximity of nozzle 214, air flow 2002 would be blocked from traveling upstream into hotend 204 by jacket outlet 408 during extrusion. This blockage would reduce the necessity of air assist assembly 1806 and boot 1810, although having the upstream end of extruderhead bore 502 air-tight could improve the efficiency of the air assist. Depending on how closely jacket outlet 408 fit inside bore extension 2010, air flow 1802 would be largely obstructed by jacket outlet 408 during extrusion. If the annular gap between jacket outlet 408 and bore extension 2010 were large enough to permit significant air flow out of bore extension 2010, air flow 1802 could be moderated to control effects on extrudate 1822 as it is deposited. One method of moderating air flow 1802 under these conditions would be to add an alternate conduit to carry the air from an air exhaust vent 2012 to an inlet at location 1830 (FIG. 19). The alternative dispensation of the air could be actuated by the motion of the jacket as described earlier or be actuated by pressure changes. Pressure operated air exhaust vent 2012 in air conduit 1814 could open and release exhaust air 2014 when air outlets 2008 are obstructed. Air vent 2012 could be as simple as an outlet on air conduit 1814 sealed by an elastic band around conduit 1814. If air flow 1802 produced excessive air pressure, this elastic band would expand away from conduit 2014 and leak off air. Alternatively, this arrangement could be operated by controlling the activation and deactivation of air source 1816.

FIGS. 22 and 23 illustrate the retraction process using this embodiment of air assist. As soon as jacket outlet 408 begins to move up past air outlets 2008, air vent 2012 will close as nozzle air flow 1828 streams past jacket outlet 408, breaking extrudate string 1826 and pushing extrudate 1822 down onto solidified extrudate 1824. Overall, a nozzle air assist system will function similarly to a filament feed air assist system, with the exception that its air flow will be generally cooler because it travels less distance through the heated portions of the extruderhead. Also, because its air outlets are oriented to jet the air flow radially and perpendicularly across the jacket outlet, it will tend to have a more pronounced cleaning effect.

Higher pressure air could be used which if active during extrusion would further inhibit the occurrences of backflow of extrudate 1822 into annular gap 1804 at nozzle 214. Active control of air source 1816 would give more nuanced control of the effects of nozzle airflow 1828. Activation of air source 1816 could be triggered by the printer's controller, by the controller commands to filament feeding mechanism 104 to retract, or by the mechanical movement of filament feeding mechanism 104 during retraction.

Embodiments with Manual Extrusion Devices

Filament tip retaining jackets are equally useful for using with manually operated filament extruders. The ability to quickly change filaments and to use different extrusion-bead sizes would improve the functionality of a manual extruder significantly. Because manual extruders are operated by hand, they are typically used with just a short coil of filament rather than a bulky spool. Short coils have to be frequently reloaded. Also, manual extruders are often used to repair multiple objects during the same session, requiring frequent changes of material type and color. Purging a manual extruder clean after material changes can be slow and laborious. Frequent filament changes can be mitigated by having multiple extruders, each with a dedicated color, but that is costly. Furthermore, nozzles in these extruders are often permanently fixed to the extruderhead, limiting the user to one extrusion-bead size.

While many of these drawbacks could be remediated with improved designs or components, those solutions would also increase the cost of the devices. In contrast, adapting them to use a filament tip retaining jacket would require minor modifications and would significantly improve their performance in these respects. In fact, because manual extruders typically have short, direct feed systems, adapting them to use a jacket is simpler with these extrusion devices than many 3-D printers. Because the jacket would not need to traverse a long filament feed system in this application, the jacket body could be made into a longer tube that extended from the outlet of the extruder's feed mechanism to the point of extrusion. Changing out the filament would then require only retracting the jacket inlet section out of the feed mechanism, and then pulling the jacket out manually. If reloading the same kind of filament, the jacket could be left in the feed mechanism with just the jacket inlet exposed. The old filament stub could then be manually pulled out of the still hot jacket, and the fresh one inserted. If fully removed, the jacket could be manually pushed back into the feed mechanism almost all the way in before using the slower feed mechanism to finish seating it. Thus, reloading or changing filaments would be a fast and simple process with a filament tip retaining jacket. Different jackets could also have different outlet sizes, making changing extrusion bead size just as quick and easy. 3-D Printer Configuration for Use with Filament Tip Retaining Jacket

Both existing and new FFF 3-D printers or other filament-supplied extrusion devices can be configured to work with a filament tip retaining jacket by adapting hardware and software parameters to its use. Hardware parameters include optimizing the filament feed path to allow unimpeded bidirectional movement of the jacket. Feed tubes should have internal diameters to accommodate the jacket diameter and length, and should be routed to avoid tight radius turns. Connections and junctions between feed path components including tubes and hubs should be internally smooth, without snags or internal upsets that may restrict the jacket's movements forward or backwards. Filament runout sensors should allow passage of the jacket without catching on internal sensor components. The extruder drive gear should be configured to accept and reliably grip a range of diameters that include that of the filament and of the jacket. The extruderhead nozzle should be configured to allow the jacket outlet end to extend through it, or to seal against it. Embodiments including an air assist require an air source, air conduit, and air pathways.

Software parameters include optimization of both the device firmware and the slicer software preparing the g-code print files. Firmware controlling filament changing procedures should be configured to take advantage of the speed and efficiency of changing filaments without cutting or purging, as well as to manage the jacket position when not extruding to optimize thermal management. Slicer software should be configured to coordinate retraction operations, and optimize print parameters for the jacket used on each filament including extrusion width, print speed, temperature, and layer height, as well as other parameters that are affected by the jacket characteristics.

### Materials and Manufacture

As described above, a working prototype of an embodiment of the filament tip retaining jacket was made of miniature stainless-steel tubing of the type used to make hypodermic needles, also referred to as hypo-tube. Manufacture of production versions of this embodiment could likewise use this type of metal tubing. Hypo-tube is readily available in the range of sizes required, is easily shaped, and very capably performs the required functions. Using an appropriately sized hypo-tube blank, the jacket could be formed in one piece. Some forming operations could include the following: swaging the outlet end to the required diameters, cutting the inlet end and slip-coupling barbs with electrical discharge machining, and rolling and stamping surface textures. Specific elements such as thickened ridges or outlet components could also be soldered onto the jacket body.

While re-usable jackets would be constructed to be as durable as any conventional extruderhead component, inexpensive and fully functional jackets could be treated as a consumable. As the jacket functions primarily as a liner, it needs only to be robust enough to travel through the feed system without damage and to maintain fluid control within the confines of the extruderhead barrel which would itself provide the jacket support during extrusion. Because the service life of one jacket could be expected to be as short as the printing of a single 1-kilogram spool of filament, which can take less than 24 hours, it's structure would not need to be as robust as a permanent extruderhead component or conventional nozzle. A jacket manufactured to last a couple hundred hours of print time would be many times more durable than what would likely be required of it in regular use. Even the use of highly abrasive filament materials could be accommodated by replacing the jacket with each new spool. Ideally, the manufacturing of each jacket would be inexpensive enough that they could be sold in variety packs, or in packs of dozens. One jacket or more could be included with every spool of filament with characteristics specifically designed for that filament without adding appreciable expense to the cost of the filament. As the prototype jacket fabricated from hypo-tube cost less than $2.00 to make, production units produced at scale should cost considerably less. A typical spool of PLA filament currently costs around $20 per kilogram. Considering that the use of a jacket could potentially save more than half the filament expended when printing multi-color, the expense of these jackets would be more than offset by the cost of the filament that the use of these jackets could save, not to mention the cost of the time also saved.

Jackets could be made of many materials other than stainless-steel hypo-tube, as long as those materials can produce resilient, semi-rigid tubes with thin walls and are able to resist temperatures in excess of 200 degrees Celsius. Materials that can be stamped, press-molded, or otherwise mass produced with relative precision would be particularly advantageous. Some examples of these kinds of materials include metal foil, chopped or strand carbon or glass fiber, refractory bonded graphite, polytetrafluoroethylene (PTFE), polyimide, fluoroelastomer (FKM), perfluoroelastomer (FFKM), polymers of the polyaryletherketone (PAEK) family, or any combination thereof. If metal foil or polymer film is used to form the liquid-tight tube of the jacket using overlapping seams, it should be of such thinness that more than one layer can fit within the annular space between the filament and the inner walls of the filament feed system, filament feeding mechanism, and the extruderhead. For example, in a jacket for a standard 1.75-millimeter filament used in a 3-D printer that has a filament feed system with an inner diameter of 2.25 millimeters, the annular space would be 0.25 millimeter. Thus, in order to create a seam of overlapping edges that would fit, the foil or film would need to be less than 0.125 millimeter. If the printer had a smaller bore or the foil or film overlapped more than twice, that measurement would have to be still thinner. In a jacket for 1.5-millimeter filament in a printer with a 2.0-millimeter bore (standard for 1.75-millimeter filaments), the annular space would likewise be 0.25 millimeter.

### Further Embodiments Not Illustrated

The innovation of a filament tip retaining jacket comprising a sleeve carried on the end of the filament and loading into the extruderhead from the direction of feed can be further developed into embodiments using other means of jacket positioning and jacket/filament attachment. For example, a supplemental drive or positioning mechanism located within or in close proximity to the extruderhead and acting on the jacket itself would be able to position the jacket within the extruderhead from the direction of feed in coordination with the filament feed mechanism. Such a mechanism would act as an intermediate positioner, wherein the jacket would be carried by the filament to a point of engagement with the positioner. The positioner would then supplement or reinforce the action of the filament upon the jacket, positioning it precisely within the extruderhead. Combined with provisions to either actively or passively cool the jacket when retracted from the hotend, this kind of supplemental jacket positioner would reduce the reliance of the jacket/filament attachment on the function of the kinds of slip-drag coupling described above while the leading end of the filament is heated and soft. After retraction by the supplemental jacket positioner and cooled, the jacket/filament connection would be secured by the filament solidification and adherence to the inside of the jacket, ensuring its attachment when moving through the feed system. In such an embodiment, the variable adhesiveness of the filament itself determined by its temperature would function as the means of slidable attachment described herein as a slip-drag coupling. A secondary jacket positioner could also reduce the possibility of extrusion occurring while the jacket is being heated before fully seated. This kind of jacket positioner could provide further means for effectively positioning the jacket/filament within the extruderhead to modulate heat transfer when not extruding, and to utilize the jacket as a kind of shuttle valve controlling air assist air-flow.

This means of jacket positioning could comprise a secondary drive gear set coupled to and powered by the filament feed mechanism and that directly engages with the filament tip retaining jacket while it is near or inside the extruderhead. This drive gear set could alternatively be powered by a dedicated motor or solenoid controlled independently of the filament feed mechanism. This positioner could further comprise a carrier or sleeve that fit within the extruderhead and into which the jacket would insert. This carrier could be controlled by a direct linkage to a motor or solenoid, remain in local proximity to the extruderhead, and would carry the jacket/filament assembly and position it within the extruderhead as needed. Other means of positioning the jacket within the extruderhead from the direction of feed evident to a person skilled in the art would fall within the scope of this disclosure.

### Advantages

From the description above, a number of advantages to the use of some embodiments of a filament tip retaining jacket when 3-D printing become evident:
a. Clean retractions of the filament at the end of extrusions leaving no residual filament material in the extruderhead will be possible, enabling very fast changes of print materials during the print process.
b. Clean retractions will also help to prevent cross-contamination of filament materials during these changes, eliminating the waste of filament material used to purge the extruderhead of the previous material before proceeding with the new material.
c. Reducing the need to purge the extruderhead after material changes will save the significant amount of time expended during those purges as well as the time required for the extra extruderhead movements involved.
d. Cutting the filament during filament changes and associated extruderhead movements is made unnecessary.
e. When filament jackets are used in conjunction with an automatic multi-material changing system, a basic 3-D printer equipped with a single extruderhead will be able to print multi-color and multi-material objects much faster and with much less waste than when using equivalent systems without jackets.
f. Rapid retraction of the filament from the hotend will be possible, reducing the negative effects that can be caused by the extended exposure of the filament to high heat while not extruding, in turn allowing the use of higher temperatures required for faster feed rates and print speeds.
g. Rapid retraction will also reduce the risk of uncontrolled oozing or dripping of liquified material from the extruderhead when not extruding.
h. In embodiments where the jacket outlet extends beyond the nozzle, rapid retraction will further include automatically lifting the jacket outlet above the build area of the printer, reducing the risk of collision with the fabricated object during rapid travel movements without increasing print times or creating significant vibrations.
i. A previously unavailable means to control the transfer of heat from the hotend to the filament while not extruding is enabled by the capability to modulate the position of the filament inside the extruderhead, mitigating previous limitations imposed by hotend and coldend thermal capacitance.
j. A means to control the transfer of heat is enabled by conducting and controlling air flow through the cold end provided by the jacket/bore annulus and valve type action of the jacket movements.
k. A means to influence extrudate separation from the extruderhead, printed surface finish, and extruderhead debris clearing is provided by the jacket/bore annulus and valve type action of the jacket movements. Some embodiments will facilitate the implementation of simple air assist systems to manage extrudate stringing and clearing residual extrudate from the tip of the extruderhead at the end of extrusion sequences as well as improve surface finish of the fabricated part. These air assist systems can function automatically in tandem with rapid retraction and not require check valves or additional control systems.
l. In embodiments where the jacket outlet extends to the point of extrusion, extrusion characteristics conventionally determined by the nozzle will be defined by the jacket outlet, and thus be specific to the filament that carries it. Furthermore, because the jacket changes automatically with the filament, the following will be possible with these embodiments:
   i. Reduction of problems such as wear and clogging, and when such problems occur, they are easily resolved by changing filaments;
   ii. Extrusion characteristics such as diameter of the extrudate can be made different for each filament.

### Conclusions, Ramifications, and Scope

Accordingly, the reader will see that the filament tip retaining jacket of the various embodiments disclosed can be used to retain the unextruded liquified filament to the filament body so that it can be cleanly and quickly retracted from the extruderhead, facilitating rapid material changes during printing. When used in conjunction with currently available multi-material handling systems, jackets on each filament could enable single extruderhead 3-D printers to print multi-color and multi-material objects with similar efficiencies as when printing single material objects. Multiple extruders, control systems, or tool changers are made unnecessary. In addition, rapid and automatic retractions of the filament made possible with some embodiments of the jacket introduce new possibilities of temperature management of the filament, as well as control of oozing and stringing. Because the filament tip retaining jacket is conveyed by the filament itself, it makes extrusion characteristics conventionally defined by the extruderhead integral to each filament, automatically changing with each filament change. Furthermore, because the jacket inserts with the filament into the extruderhead from the direction of the feed, rather than separately at the extruderhead outlet, changing jackets becomes an automatic part of the procedure to change filaments without needing complex tool changer mechanisms or extruderhead movement procedures. Existing FFF 3-D printers can be adapted with limited modification to print with filament using an embodiment of the jacket, while still preserving compatibility with un-jacketed filament. Furthermore, other embodiments open the potential for new innovations in extruderhead design and operation. Indeed, the method and device disclosed here could introduce a new class of filament-supplied extruders with yet to be innovated functions and uses.

Although the description above contains many specifics, these should not be construed as limiting the scope of the embodiments but rather providing illustrations of some of several embodiments. For example, the configuration of extruderheads illustrated here are based on currently existing designs; however, the scope of these embodiments extends to other extruderhead configurations not shown, particularly extruderheads designed to incorporate the functions provided by a filament tip retaining jacket. Extruderheads included within the scope of this disclosure include configurations utilizing slots, brackets, holders, receivers, slides, and other means of retaining a filament tip retaining jacket in proximity to a means of liquification, irrespective of the degree of enclosure around the jacket. Furthermore, the jackets discussed in this disclosure comprise cross-sectional shapes suitable for use with round filament, but could include configurations suitable for those with ovoid, square, rectangular, polygonal, ribbon, and hollow shapes. Likewise, these filaments could be of a single material, or composite or coextruded. Filament types that fall under the scope of this disclosure include those of any diameter, including thin, flexible strands as well as thick, rigid rods or wafers. Further filament types include any type of feedstock that is supplied as solid strands, ribbons, wires, rods, or wafers, and subsequently liquified inside a containing structure through which it is extruded. Thus, the scope of the embodiments should be determined by the appended claims and their legal equivalents, rather than by the examples given.

I claim:

1. A filament tip retaining jacket for an extrusion device using a filament feedstock, said device comprising:
a. a feedstock comprising a filament;
b. a filament feeding mechanism; and
c. an extruderhead comprising a means of liquification to melt said filament;
d. said filament tip retaining jacket comprising a tube:
i. said tube comprising an elongated body having an interior passage connecting an inlet end to an outlet end;
ii. said tube further comprising a means of slidable attachment configured to allow said filament to insert inside said inlet end and said interior passage and to hold said elongated body to said filament when said filament is retracted;
iii. said tube configured to pass through said filament feeding mechanism; and
iv. said tube outlet end configured to insert into said extruderhead means of liquification along with said filament;
v. whereby said tube substantially contains said filament within said tube while a portion of said filament is liquified by said means of liquification and extruded; and
vi. whereby said tube substantially retains to said filament said liquified portion of said filament left remaining inside said tube when said tube is removed from said extruderhead.

2. The filament tip retaining jacket of claim 1 wherein:
a. said device further comprises a point of extrusion; and
b. said outlet end of said tube extends to said point of extrusion during said extrusion.

3. The filament tip retaining jacket of claim 2 wherein said outlet end of said tube extends beyond said extruderhead during said extrusion.

4. The filament tip retaining jacket of claim 1 wherein said jacket further comprises a means of forming a barrier to flow between said tube outlet end and a bore of said extruderhead, said means of forming a barrier to flow comprising at least one means selected from a group consisting of:
a. at least one seal made of elastomeric material;
b. at least one adjoining surface comprising a compliant material;
c. a juncture having an interlocking interface;
d. a juncture having a tapering interface; and
e. extending said tube outlet end out of an outlet end of said extruderhead bore.

5. The filament tip retaining jacket of claim 1 wherein said means of slidable attachment comprises at least one feature selected from a group consisting of a protuberance and a barb.

6. The filament tip retaining jacket of claim 1 wherein said inlet end of said tube has at least one slit.

7. The filament tip retaining jacket of claim 1 wherein said tube further comprises an outer surface having a texture comprising a plurality of at least one feature type selected from a group consisting of knurls, ridges, bumps, and grooves.

8. The filament tip retaining jacket of claim 1 wherein:
a. said device further comprises an air assist system comprising at least one conduit for conducting a flow of air;
b. said tube inserts into a bore of said extruderhead to form an annular space within said extruderhead between said tube and said extruderhead bore; and
c. said air assist conduit connects an air source to said annular space;
d. whereby a flow of air is conducted through said annular space to remove liquified filament material from outside said jacket tube and from inside said extruderhead bore.

9. The filament tip retaining jacket of claim 1 wherein said tube is made at least in part of a metal material comprising at least one form selected from a group consisting of tubing, sheet, and foil.

10. The filament tip retaining jacket of claim 1 wherein said tube is made at least in part with fiber reinforcement comprising at least one material selected from a group consisting of carbon fiber and glass fiber.

11. The filament tip retaining jacket of claim 1 wherein said tube is made at least in part of a polymer comprising at least one material selected from a group consisting of polytetrafluoroethylene, polyimide, fluoroelastomer, perfluoroelastomer, and polyaryletherketone.

12. The filament tip retaining jacket of claim 1 wherein said tube has an outer diameter of less than 2 millimeters and an inner diameter of less than 1.75 millimeters.

13. The filament tip retaining jacket of claim 1 wherein said tube has an outer diameter of less than 3 millimeters and an inner diameter of more than 1.75 millimeters.

14. The filament tip retaining jacket of claim 1 wherein said device further comprises a means of positioning said tube in relation to said means of liquification, said means of positioning comprising a direct engagement with said tube whereby said tube is urged forward and backward in tandem with said filament while said tube and said filament are inside said extruderhead.

15. The filament tip retaining jacket of claim 1 wherein said device is a 3-D printer.

16. The filament tip retaining jacket of claim 1 wherein said device is a manually operated extruder.

17. A method of extrusion using a filament feedstock with a filament tip retaining jacket, said method comprising:
a. providing a feedstock comprising a filament having a leading portion connected to a following portion;
b. providing a filament tip retaining jacket, said jacket comprising a tube, said tube comprising an elongated body with an interior passage connecting an inlet end to an outlet end, said tube further comprising a means of slidable attachment configured to allow said filament to insert inside said inlet end and said interior passage and to hold said elongated body to said filament when said filament is retracted;
c. attaching said tube to said filament by inserting said filament leading portion through said tube inlet end into said interior passage, said filament following portion following said leading portion into said tube inlet end and said means of slidable attachment, said tube encasing said filament leading portion, said means of slidable attachment attaching said tube to said filament following portion;
d. loading said tube and said filament into a filament feeding mechanism;
e. feeding said tube and said filament through said filament feeding mechanism and into an extruderhead comprising a means of liquification for melting said filament;
f. melting said filament leading portion within said tube by heating said tube with said means of liquification; and
g. urging said liquified filament leading portion through said tube to extrude said liquified filament leading portion at a point of extrusion in a process of extrusion;
h. whereby said tube substantially contains said filament leading portion within said tube while said filament leading portion is liquified, conveying said liquified filament leading portion through said extruderhead during said process of extrusion, and substantially retaining said filament leading portion left remaining in said tube to said filament following portion when said filament is removed from said extruderhead.

18. The method of claim 17, said method further comprising modulating a transference of heat energy from said means of liquification to said filament leading portion by means of modulating the proximity of said filament tip retaining jacket to said means of liquification.

19. The method of claim 17, said method further comprising using a plurality of said filament tip retaining jackets with a multi-material handling system to fabricate at least one 3-dimensional object using a plurality of filament having a plurality of at least one characteristic selected from a group consisting of coloration and composition.

20. The method of claim 17, said method further comprising:
a. providing an air assist system comprising at least one conduit for conducting a flow of air; and
b. providing a first connection from an air source to said air assist conduit and a second connection from said air assist conduit to an annular space between said jacket tube and a bore within said extruderhead;
c. whereby conducting a flow of air through said annular space to remove liquified filament material from outside said jacket tube and from inside said extruderhead bore.

21. A method of modulating a transference of heat energy to a filament feedstock using a filament tip retaining jacket, said method comprising:
a. providing a feedstock comprising a filament;
b. providing a filament tip retaining jacket comprising a tube, said tube comprising an elongated body having an interior passage connecting an inlet end to an outlet end;
c. inserting the leading end of said filament into said inlet end of said tube;
d. feeding said tube and said filament through a filament feeding mechanism;
e. inserting said outlet end of said tube into an extruderhead comprising a means of liquifying said filament;
f. modulating a transference of heat energy from said means of liquifying to said filament by modulating the proximity of said tube containing said filament relative to said means of liquifying.

22. A feedstock tip retaining jacket for an extrusion device using a contiguous solid body feedstock, said device comprising:
a. a feedstock comprising a contiguous solid body further comprising a leading portion connected to a following portion;
b. a feedstock feeding mechanism further comprising a feedstock feed path; and
c. an extruderhead comprising a liquifier to melt said feedstock, said feedstock being fed into said extruderhead and said liquefier by said feedstock feeding mechanism;
d. said feedstock tip retaining jacket wherein comprising a tube:
i. said tube comprising an elongated body having an interior passage connecting an inlet end to an outlet end;
ii. said tube further comprising a means of slidable attachment configured to allow said feedstock to insert inside said inlet end and to slide forward into said interior passage when said feedstock is fed forward and to hold said elongated body to said feedstock when said feedstock is retracted;
iii. said tube configured with an outer surface that is substantially streamlined and that has an outer diameter that measures less than the smallest inner diameter within said feedstock feed path such that said tube passes forward and backward through said feedstock feeding mechanism and said feedstock feed path;
iv. said elongated body encasing said feedstock leading portion; and
v. said elongated body slidably joined to said feedstock following portion by said means of slidable attachment;
vi. said elongated body outlet end inserting into said extruderhead and said liquifier along with said feedstock;
vii. whereby said tube substantially contains said feedstock leading portion within said tube while said feedstock leading portion is liquified by said liquefier, conducts said liquified feedstock leading portion through said extruderhead during a process of extrusion, and retains said feedstock leading portion to said feedstock following portion when said feedstock is removed from said extruderhead even while said leading portion is liquified.

23. The feedstock tip retaining jacket of claim 22 wherein:
a. said device further comprises an air assist system comprising at least one conduit for conducting a flow of air;
b. said tube inserts into a bore of said extruderhead to form an annular space within said extruderhead between said tube and said extruderhead bore; and
c. said air assist conduit connects an air source to said annular space;
d. whereby a flow of air is conducted through said annular space to remove liquified feedstock material from outside said jacket tube and from inside said extruderhead bore.

24. The inventions substantially as described and shown herein.
